(19) United States
(12) Patent Application Publication
(10) Pub. No.: US 2005/0141926 A1
(43) Pub. Date: Jun. 30, 2005

(54) Method and apparatus for using a transfer assist layer in a multi-pass electrophotographic process utilizing adhesive toner transfer

(76) Inventors: James A. Baker, Hudson, WI (US); Truman F. Kellie, Lakeland, MN (US); Brian P. Teschendorf, Vadnais Heights, MN (US); Gay Herman, Cottage Grove, MN (US); Dan LaVigne, Shoreview, MN (US); A. Kristine Fordahl, St. Paul, MN (US)

Correspondence Address: KAGAN BINDER, PLLC;Suite 200, Maple Island Building, 221 Main Street North, Stillwater, MN, 55082, US

(21) Appl. No.: 10/884,339

(22) Filed: Jun. 30, 2004

Related U.S. Application Data
(60) Provisional application No. 60/533,715, filed on Dec. 31, 2003.

(51) Int. Cl. G03G 15/16

(52) U.S. Cl. 399/296

(57) ABSTRACT

A method of producing a composite image on a final image receptor from image data in a multiple pass electrophotographic system is provided. The method includes steps for applying liquid transfer assist material comprising charged particles of transfer assist material to at least a portion of an element of the electrophotographic system, along with charged toner particles, in order to provide a composite image layer on a final image receptor through transfer of the composite image layer from another element in the system.

### REFERENCE TO RELATED APPLICATION

This application claims the benefit of U.S. Provisional application Ser. No. 60/533,715, filed Dec. 31, 2003, entitled “METHOD AND APPARATUS FOR USING A TRANSFER ASSIST LAYER IN A MULTI-PASS ELECTROPHOTOGRAPHIC PROCESS UTILIZING ELASTOMERIC TONER TRANSFER.

Each of the following copending U.S. patent applications of the present Assignee are incorporated herein by reference in its respective entirety:

U.S. Ser. No. ______, filed on even date herewith, entitled “METHOD AND APPARATUS FOR USING A TRANSFER ASSIST LAYER IN A MULTI-PASS ELECTROPHOTOGRAPHIC PROCESS WITH ELECTROSTATICALLY ASSISTED TONER TRANSFER,” Attorney Docket No. SAM0010/US;
U.S. Ser. No. ______, filed on even date herewith, entitled “METHOD AND APPARATUS FOR USING A TRANSFER ASSIST LAYER IN A TANDEM ELECTROPHOTOGRAPHIC PROCESS WITH ELECTROSTATICALLY ASSISTED TONER TRANSFER,” Attorney Docket No. SAM0024/US; and
U.S. Ser. No. ______, filed on even date herewith, entitled “METHOD AND APPARATUS FOR USING A TRANSFER ASSIST LAYER IN A TANDEM ELECTROPHOTOGRAPHIC PROCESS UTILIZING ADHESIVE TONER TRANSFER,” Attorney Docket No. SAM0028/US.

### TECHNICAL FIELD

The present invention relates to methods and systems that assist toner transfer for use with electrophotographic processes, and particularly relates to the use of such methods and systems with liquid toner materials.

### BACKGROUND OF THE INVENTION

Electrophotography forms the technical basis for various well-known imaging processes, including photocopying and some forms of laser printing. Other imaging processes use electrostatic or ionographic printing. Electrostatic printing is printing where a dielectric receptor or substrate is “written” upon imagewise by a charged stylus, leaving a latent electrostatic image on the surface of the dielectric receptor. This dielectric receptor is not photosensitive and is generally not reusable. Once the image pattern has been “written” onto the dielectric receptor in the form of an electrostatic charge pattern of positive or negative polarity, oppositely charged toner particles are applied to the dielectric receptor in order to develop the latent image. An exemplary electrostatic imaging process is described in U.S. Pat. No. 5,176,974.

In contrast, electrophotographic imaging processes typically involve the use of a reusable, radiation sensitive, temporary image receptor, known as a photoreceptor, in the process of producing an electrophotographic image on a final, permanent image receptor. A representative electrophotographic process involves a series of steps to produce an image on a receptor, including charging, exposure, development, transfer, fusing, cleaning, and erasure.

In the charging step, a photoreceptor is covered with charge of a desired polarity, either negative or positive, typically with a corona or charging roller. In the exposure step, an optical system, typically a laser scanner or diode array, forms a latent image by selectively exposing the photoreceptor to electromagnetic radiation, thereby discharging the charged surface of the photoreceptor in an imagewise manner corresponding to the desired image to be formed on the final image receptor. The electromagnetic radiation, which may also be referred to as “light” or actinic radiation, may include infrared radiation, visible light, and ultraviolet radiation, for example.

In the development step, toner particles of the appropriate polarity are generally brought into contact with the latent image on the photoreceptor, typically using an electrically-biased development roller to bring the charged toner particles into close proximity to the photoreceptive element. The polarity of the development roller should be the same as that of the toner particles and the electrostatic bias potential on the developer roller should be higher than the potential of the imagewise discharged surface of the photoreceptor, so that the toner particles migrate to the photoreceptor and selectively develop the latent image via electrostatic forces, forming a toned image on the photoreceptor.

In the transfer step, the toned image is transferred from the photoreceptor to the desired final image receptor; an intermediate transfer element is sometimes used to effect transfer of the toned image from the photoreceptor with subsequent transfer of the toned image to a final image receptor. The transfer of an image typically occurs by one of the following two methods: elastomeric assist (also referred to herein as “adhesive transfer”) or electrostatic assist (also referred to herein as “electrostatic transfer”).

Elastomeric assist or adhesive transfer refers generally to a process in which the transfer of an image is primarily caused by balancing the relative surface energies between the ink, a photoreceptor surface and a temporary carrier surface or medium for the toner. The effectiveness of such elastomeric assist or adhesive transfer is controlled by several variables including surface energy, temperature, force, and toner rheology. An exemplary elastomeric assist/adhesive image transfer process is described in U.S. Pat. No. 5,916,718.

Electrostatic assist or electrostatic transfer refers generally to a process in which transfer of an image is primarily affected by electrostatic charges or charge differential phenomena between the receptor surface and the temporary carrier surface or medium for the toner. Electrostatic transfer may be influenced by surface energy, temperature, and force, but the primary driving forces causing the toner image to be transferred to the final substrate are electrostatic forces. An exemplary electrostatic transfer process is described in U.S. Pat. No. 4,420,244.

In the fusing step, the toned image on the final image receptor is heated to soften or melt the toner particles, thereby fusing the toned image to the final receptor. An alternative fusing method involves fixing the toner to the final receptor under high force with or without heat. In the cleaning step, any residual toner remaining on the photoreceptor after the transfer step is removed. Finally, in the erasing step, the photoreceptor charge is reduced to a substantially uniformly low value by exposure to radiation of a particular wavelength band, thereby removing remnants of the original latent image and preparing the photoreceptor for the next imaging cycle.

Electrophotographic imaging processes may also be distinguished as being either multi-color or monochrome printing processes. Multi-color printing processes are commonly used for printing graphic art or photographic images, while monochrome printing is used primarily for printing text. Some multi-color electrophotographic printing processes use a multi-pass process to apply multiple colors as needed on the photoreceptor to create the composite image that will be transferred to the final image receptor, either via an intermediate transfer member or directly. One example of such a process is described in U.S. Pat. No. 5,432,591.

In one exemplary electrophotographic, multi-color, multi-pass printing process, the photoreceptor takes the form of a relatively large diameter drum to permit an arrangement of two or more multi-color development units or stations around the circumference perimeter of the photoreceptor. Alternatively, toners of varying colors can be contained in development units that are arranged on a moveable sled such that they can be individually moved into place adjacent to the photoreceptor as needed to develop a latent electrophotographic image. A single rotation of the photoreceptor drum generally corresponds to the development of a single color; four drum rotations and four sled movements are therefore required to develop a four color (e.g. full color) image. The multi-color image is generally built up on the photoreceptor in an overlaid configuration, and then the full color image is transferred with each color remaining in imagewise registration, to a final image receptor, either directly or via an intermediate transfer element.

In multi-pass processes utilizing a central photoreceptive element, it is important that the pigmented toner particles are transparent with respect to the radiation used to discharge the photoreceptive element. As the multiple colors are sequentially developed into a complete image on the photoreceptive element, it is frequently necessary to “layer” colors upon one another using an electrophoretic process that requires the photoreceptive element to remain sensitive to discharge-inducing radiation even when one or more latent images have already been developed on the photoreceptive element. U.S. Pat. No. 5,916,718 describes this concept in greater detail.

In an exemplary electrophotographic, four-color, four-pass full color printing process, the steps of photoreceptor charging, exposure, and development are generally performed with each revolution of the photoreceptor drum, while the steps of transfer, fusing, cleaning, and erasure are generally performed once every four revolutions of the photoreceptor. However, multi-color, multi-pass imaging processes are known in which each color plane is transferred from the photoreceptor to an intermediate transfer element on each revolution of the photoreceptor. In these processes, the transfer, cleaning and erasure steps are generally performed upon each revolution of the photoreceptor, and the full-color image is built up on the intermediate transfer element and subsequently transferred from the intermediate transfer element to the final image receptor and fused.

Alternatively, electrophotographic imaging processes may be purely monochromatic. In these systems, there is typically only one pass per page because there is no need to overlay colors on the photoreceptor. Monochromatic processes may, however, include multiple passes where necessary to achieve higher image density or a drier image on the final image receptor, for example.

A single-pass electrophotographic process for developing multiple color images is also known and may be referred to as a tandem process. A tandem color imaging process is discussed, for example in U.S. Pat. No. 5,916,718 and U.S. Pat. No. 5,420,676. In a tandem process, the photoreceptor accepts color toners from development stations that are spaced from each other in such a way that only a single pass of the photoreceptor results in application of all of the desired colors thereon.

In an exemplary four-color tandem process, each color may be applied sequentially to a photoreceptive element that travels past each development station, overlaying each successive color plane on the photoreceptor to form the complete four-color image, and subsequently transferring the four-color image in registration to a final image receptor. For this exemplary process, the steps of photoreceptor charging, exposure, and development are generally performed four times, once for each successive color, while the steps of transfer, fusing, cleaning, and erasure are generally performed only once. After developing the four-color image on the photoreceptor, the image may be transferred directly to the final image receptor or alternatively, to an intermediate transfer member and then to a final image receptor.

In another type of multi-color tandem imaging apparatus, each individual color's development station may include a small photoreceptor on which each color's contribution to the total image is plated. As an intermediate transfer member passes each photoreceptor, the image is transferred to the intermediate transfer member. The multi-color image is thereby assembled on the intermediate transfer element in overlaid registration of each individual colored toner layer, and subsequently transferred to the final image receptor.

Two types of toner are in widespread, commercial use: liquid toner and dry toner. The term “dry” does not mean that the dry toner is totally free of any liquid constituents, but connotes that the toner particles do not contain any significant amount of solvent, e.g., typically less than 10 weight percent solvent (generally, dry toner is as dry as is reasonably practical in terms of solvent content), and are capable of carrying a triboelectric charge. This distinguishes dry toner particles from liquid toner particles.

A typical liquid toner composition generally includes toner particles suspended or dispersed in a liquid carrier. The liquid carrier is typically a nonconductive dispersant, to avoid discharging the latent electrostatic image. Liquid toner particles are generally solvated to some degree in the liquid carrier (or carrier liquid), typically in more than 50 weight percent of a low polarity, low dielectric constant, substantially nonaqueous carrier solvent. Liquid toner particles are generally chemically charged using polar groups that dissociate in the carrier solvent, but do not carry a triboelectric charge while solvated and/or dispersed in the liquid carrier. Liquid toner particles are also typically smaller than dry toner particles. Because of their small particle size, ranging from about 5 microns to sub-micron, liquid toners are capable of producing very high-resolution toned images, and are therefore preferred for high resolution, multi-color printing applications.

A typical toner particle for a liquid toner composition generally comprises a visual enhancement additive (for example, a colored pigment particle) and a polymeric binder. The polymeric binder fulfills functions both during and after the electrophotographic process. With respect to processability, the character of the binder impacts charging and charge stability, flow, and fusing characteristics of the toner particles. These characteristics are important to achieve good performance during development, transfer, and fusing. After an image is formed on the final receptor, the nature of the binder (e.g. glass transition temperature, melt viscosity, molecular weight) and the fusing conditions (e.g. temperature, pressure and fuser configuration) impact durability (e.g. blocking and erasure resistance), adhesion to the receptor, gloss, and the like. Exemplary liquid toners and liquid electrophotographic imaging process are described by Schmidt, S. P. and Larson, J. R. in Handbook of Imaging Materials Diamond, A. S., Ed: Marcel Dekker: New York; Chapter 6, pp 227-252.

The liquid toner composition can vary greatly with the type of transfer used because liquid toner particles used in adhesive transfer imaging processes must be “film-formed” and have adhesive properties after development on the photoreceptor, while liquid toners used in electrostatic transfer imaging processes must remain as distinct charged particles after development on the photoreceptor.

Toner particles useful in adhesive transfer processes generally have effective glass transition temperatures below approximately 30° C. and volume mean particle diameter between 0.1-1 micron. In addition, for liquid toners used in adhesive transfer imaging processes, the carrier liquid generally has a vapor pressure sufficiently high to ensure rapid evaporation of solvent following deposition of the toner onto a photoreceptor, transfer belt, and/or receptor sheet. This is particularly true for cases in which multiple colors are sequentially deposited and overlaid to form a single image, because in adhesive transfer systems, the transfer is promoted by a drier toned image that has high cohesive strength (commonly referred to as being “film formed”). Generally, the toned imaged should be dried to higher than approximately 68-74 volume percent solids in order to be “film-formed” sufficiently to exhibit good adhesive transfer. U.S. Pat. No. 6,255,363 describes the formulation of liquid electrophotographic toners suitable for use in imaging processes using adhesive transfer.

In contrast, toner particles useful in electrostatic transfer processes generally have effective glass transition temperatures above approximately 40° C. and volume mean particle diameter between 3-10 microns. For liquid toners used in electrostatic transfer imaging processes, the toned image is preferably no more than approximately 30% w/w solids for good transfer. A rapidly evaporating carrier liquid is therefore not preferred for imaging processes using electrostatic transfer. U.S. Pat. No. 4,413,048 describes the formulation of one type of liquid electrophotographic toner suitable for use in imaging processes using electrostatic transfer.

Photoreceptors generally have a photoconductive layer that transports charge (by an electron transfer or hole transfer mechanism) when the photoconductive layer is exposed to activating electromagnetic radiation or light. The photoconductive layer is generally affixed to an electroconductive support, such as a conductive drum or an insulative substrate that is vapor coated with aluminum or another conductor. The surface of the photoreceptor can be either negatively or positively charged so that when activating electromagnetic radiation imagewise strikes the surface of the photoconductive layer, charge is conducted through the photoreceptor to neutralize, dissipate or reduce the surface potential in those activated regions to produce a latent image.

An optional barrier layer may be used over the photoconductive layer to protect the photoconductive layer and thereby extend the service life of the photoconductive layer. Other layers, such as adhesive layers, priming layers, or charge injection blocking layers, are also used in some photoreceptors. These layers may either be incorporated into the photoreceptor material chemical formulation, or may be applied to the photoreceptor substrate prior to the application of the photo receptive layer or may be applied over the top of photoreceptive layer. A “permanently bonded” durable release layer may also be used on the surface of the photoreceptor to facilitate transfer of the image from the photoreceptor to either the final substrate, such as paper, or to an intermediate transfer element, particularly when an adhesive transfer process is used. U.S. Pat. No. 5,733,698 describes an exemplary durable release layer suitable for use in imaging processes using adhesive transfer.

Many electrophotographic imaging processes make use of intermediate transfer members (ITM's) to assist in transferring the developed toner image to the final image receptor. In particular, in a multipass electrophotographic process, these ITM's may contact the final image formed on the photoreceptor to assist transfer of entire image to the ITM. The image may then be transferred from the ITM to the final image receptor, typically through contact between the ITM and the final receptor.

In a tandem process, individual photoreceptors layer the images formed by the component colors on the ITM. When the entire image is composed in this manner it is typically transferred to the final image receptor. However, U.S. Pat. No. 5,432,591, for example, discloses the use of an offset roller to remove the entire image from a photoreceptor and transfer it to the final image receptor in a multi-pass liquid electrophotographic process. In various embodiments, the ITM may be an endless belt, a roller or a drum.

One continuing problem in electrophotography is to ensure that the toner particles transfer efficiently from the photoreceptor to the final image receptor, either directly or indirectly using an intermediate transfer member. Frequently, a noticeable percentage of the toner layer is left behind at each transfer step, resulting in reduced image fidelity, low optical density and poor image quality on the final image receptor, and toner residues on various machine surfaces that must be efficiently cleaned. This problem of low transfer efficiency is particularly troublesome for liquid electrophotographic toners, wherein slight variations in the carrier liquid content of the toned image can control the efficiency of elastomeric transfer or electrostatic transfer of the image from the photoreceptor or to a final image receptor.

Various attempts have been made to use transfer layers to assist transfer of liquid toned images from a temporary image receptor (e.g. a photoreceptor) or to a final image receptor (e.g. paper). For electrostatic or ionographic printing processes, a dielectric peel layer has been used to augment transfer from a temporary image receptor (see e.g. U.S. Pat. No. 5,176,974). Alternatively, an adhesive-coated protective laminating film has been used to augment transfer of liquid toners from a temporary electrographic receptor (see e.g. U.S. Pat. No. 5,370,960).

For liquid electrophotographic printing, a substantially continuous and uniform coating of a high viscosity or non-Newtonian liquid transfer layer has been applied to assist toner particle transfer from a photoreceptor and to a final image receptor using elastomeric or adhesive transfer. A variety of peelable or releasable transfer assist films have also been used in liquid electrophotographic printing processes wherein the photoreceptor has a surface release characteristic and elastomeric (adhesive) transfer is used to transfer the toned image from the photoreceptor surface. The peelable or releasable film is said to improve toner transferability, provide high quality and high fidelity multicolor images irrespective of the type of final image receptor or image receiving material, and improve storage stability of the final images (see e.g. U.S. Pat. Nos. 5,648,190; 5,582,941; 5,689,785; and 6,045,956).

Each of these methods for using a transfer assist material in a liquid electrophotographic printing process is directed to multi-pass processes that use adhesive or elastomeric transfer of the image from a specially-prepared photoreceptor having a surface release character, either directly to a final image receptor or indirectly to an intermediate transfer element and then to the final image receptor. Each of these methods involves the application of the transfer assist material as a substantially uniform or continuous film on the photoreceptor. Because the transfer assist material is deposited not only where the toned image is developed, but also in non-imaged background areas, a portion of the transfer material ends up in the background regions on the final image receptor, adding to the expense of using the transfer assist material and potentially degrading the appearance of the final image on plain paper. The art continually searches for improved liquid toner transfer processes, and for methods and materials that allow liquid toner particles to transfer more completely, producing high quality, durable multicolor images on a final image receptor at low cost.

### SUMMARY OF THE INVENTION

In one aspect of the invention, a method of producing a composite image on a final image receptor from image data in a multiple pass electrophotographic system is provided. The method comprises the steps of providing a photoreceptive element having a determined processing cycle and providing a transfer assist material development station containing a liquid transfer assist material comprising charged particles of transfer assist material dispersed in a first carrier liquid. The method further comprises moving at least one of the photoreceptive element and the transfer assist material development station into a processing position relative to each other and applying the transfer assist material to at least a portion of the surface of the photoreceptive element during a processing cycle of the photoreceptive element. The method also includes providing at least one development station containing charged toner particles dispersed in a second carrier liquid, wherein at least one of the photoreceptive element and each development station are moved into a processing position relative to each other and performing the following steps (a) through (c) for each development station during each complete processing cycle of the photoreceptive element: (a) applying a substantially uniform first electrostatic potential to the photoreceptive element; (b) selectively discharging the photoreceptive element in an imagewise manner to create a first latent image having a second electrostatic potential that is less than the absolute value of the first electrostatic potential; and (c) exposing the photoreceptive element to the charged toner particles, wherein the charged toner particles selectively deposit on the discharged portions of the surface of the photoreceptive element to develop the first latent image and create a toned image overlapping at least a portion of the transfer assist material on the surface of the photoreceptive element, wherein the transfer assist material and the toned image on the photoreceptive element form a composite image layer.

The method further includes the step of substantially drying the composite image layer to remove at least a major portion of the second carrier liquid during the multiple processing cycles completed by the photoreceptive element, contacting the composite image layer with a heated intermediate transfer member that provides a sufficient amount of heat and pressure to cause at least a portion of the substantially dried composite image layer to elastomerically transfer to the intermediate transfer member; and contacting the composite image layer on the intermediate transfer member with a first side of a final image receptor having two sides and applying force to the second side of the final image receptor with a backup element causing the composite image layer to elastomerically transfer to the first side of the final image receptor. Other aspects of the invention include variations in the steps and sequence of the steps described above, such as methods with image layers to transfer to intermediate transfer rollers and/or final image receptors, and other differences in the methods of producing a composite image on a final image receptor from image data in a multiple pass electrophotographic system. In another feature of the invention, a low surface energy transfer material is derived from an organosol containing charged dispersed particles derived from a silicone functional monomer.

### BRIEF DESCRIPTION OF THE DRAWINGS

The present invention will be further explained with reference to the appended Figures, wherein like structure is referred to by like numerals throughout the several views, and wherein:

FIG. 1 is a schematic view of a portion of an electrophotographic apparatus using a multi-pass configuration in an elastomeric transfer process, in accordance with the present invention;

FIGS. 2a and 2b are side schematic views of an arrangement of toner and transfer assist layers in the steps involving toner transfer from a photoreceptor to a final receptor, wherein a transfer assist layer is applied to the photoreceptor before an ink/toner layer is applied;

FIGS. 3a and 3b are side schematic views of toner and transfer assist layers arranged relative to each other, including splitting of layers with and without the use of a transfer assist layer;

FIGS. 4a and 4b are side schematic views of an arrangement of toner and transfer assist layers in the steps involving toner transfer from a photoreceptor to a final receptor, wherein a transfer assist layer is applied to the photoreceptor after an ink/toner layer is applied;

FIG. 5 is a schematic view of a portion of an electrophotographic apparatus using a multi-pass process that uses elastomeric transfer and an intermediate transfer member;

FIGS. 6a, 6b and 6c are side schematic views of an arrangement of toner and transfer assist layers in the steps involving toner transfer from a photoreceptor to an intermediate transfer member, then to a final receptor, wherein a transfer assist layer is applied to the photoreceptor before an ink/toner layer is applied;

FIGS. 7a, 7b and 7c are side schematic views of an arrangement of toner and transfer assist layers in the steps involving toner transfer from a photoreceptor to an intermediate transfer member, then to a final receptor, wherein a transfer assist layer is applied to the photoreceptor after an ink/toner layer is applied;

FIG. 8 is a top view of one example of an image plated onto a photoreceptor, wherein a transfer assist layer is applied initially to the entire imaging area; and

FIGS. 9a and 9b are top views of an image plated onto a photoreceptor, illustrating how the transfer assist layer is applied to only those areas that receive pigmented liquid toner.

### DETAILED DESCRIPTION OF THE PREFERRED EMBODIMENTS

Effective transfer of liquid toner throughout the various necessary steps required in an electrophotographic process to reach a final substrate can present some challenges. In accordance with the present invention, the inclusion of a transfer assist layer or transfer assist material in certain multi-pass electrophotographic processes may provide certain advantages, depending on where in the multi-pass process this layer is used. A transfer assist layer, as described herein, is not necessarily any one specific material or type of material, although it is preferably a generally clear material, such as a nonpigmented ink. Whether the transfer assist material is visually “clear” or not, it is necessary, just as with pigmented toners, that if the transfer assist material is applied to or developed on the photoreceptive element prior to any pigmented toner layers, it is transparent with respect to the radiation used to discharge the photoreceptive element.

In accordance with the present invention, it may be beneficial for a transfer assist layer to have release properties so that the transfer assist layer and the toner layers do not adhere to a photoreceptor, for one example. It is not a requirement that the layer provide release properties, however. A transfer assist layer may also have additional, unique benefits that add value and quality to a print aside from any problem-solving characteristics it may have, as will be discussed in further detail below.

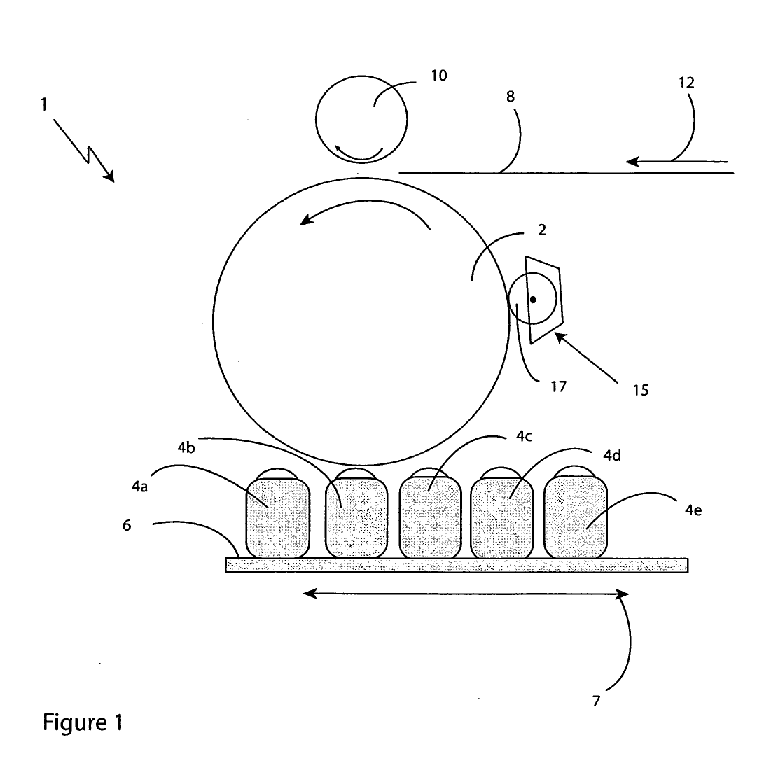

The present invention will be further explained with reference to the appended Figures, wherein like structure is referred to by like numerals throughout the several views, and wherein FIG. 1 is a schematic drawing of the relevant parts of an electrophotographic apparatus 1 using a multi-pass process that uses adhesive transfer. A photoreceptor or photoreceptive element 2 is included in the electrophotographic apparatus 1 and is positioned so that multiple development units or stations 4a, 4b, 4c, 4d, and 4e can be moved into a processing position relative to the photoreceptor 2 as needed. As described herein, when the development units or stations are in a processing position relative to a photoreceptor, the development units are preferably in contact with the photoreceptor or there may instead be a very slight gap between the development units or stations and any photoreceptors. In accordance with the invention, only one of the photoreceptor and any development units may be moved to situate the components in their desired positions relative to each other. Alternatively, both the photoreceptor and the development units may be moved to achieve the desired arrangement. When five development units are provided in a particular apparatus, it is preferable that four of the development units provide pigmented liquid ink material and that one development unit provides a transfer assist material. Further, while five development units are provided in this embodiment, more or less than five development units may be provided for a particular electrophotographic apparatus, with a wide variety of possible combinations of the number of development units containing liquid inks and the number of development units containing transfer assist materials within a single electrophotographic apparatus.

The photoreceptor 2 is shown in this non-limiting example as a drum, but may instead be a belt, a sheet, or some other photoreceptor configuration. A single rotation of the photoreceptor may be referred to as a processing cycle, which generally corresponds to the development of a single color. Thus, four rotations or processing cycles of a photoreceptor configured as a drum and four corresponding positions of development units relative to the photoreceptor would typically be required to develop a four color (e.g., full color) image. When the photoreceptor is in a different form than a drum, a processing cycle will generally correspond to one complete movement of the photoreceptor from a start position, through at least one intermediate position, then to an end position. The end position of one processing cycle may optionally correspond with the start position for the next upcoming cycle. In one exemplary embodiment, the photoreceptor is a drum having a processing cycle that includes the steps of photoreceptor charging, exposure, and development during each revolution thereof. The development units 4a-4e preferably each hold charged liquid ink or transfer assist material and include at least one development roller that attracts the charged pigmented or nonpigmented ink toner particles for application of the charged particles to discharged areas on the photoreceptor, as desired. This movement of the charged liquid ink particles onto the development roller is often referred to as electrophoretic development. The development roller is typically rotated within its development unit to ensure even coverage of the liquid toner to the photoreceptor. U.S. Pat. No. 5,916,718 describes one example of a development unit or development cartridge that may be used in a multi-pass electrophotographic process and is incorporated herein by reference. U.S. Pat. No. 5,432,591 is yet another example of a development unit or development cartridge that may be used in a multi-pass electrophotographic process, such as that of the present invention, and is incorporated herein by reference. It is understood, however, that the development units used within the processes of the present invention may include a wide variety of different configurations and equipment for transferring ink to a photoreceptor.

The process and toner formulation considerations unique to multi-pass, adhesive transfer, electrophotographic processes are discussed, for example, in U.S. Pat. No. 5,650,253, which is incorporated herein by reference. The adhesive transfer technique operates without requiring differential charge levels to transfer the image from the photoreceptor to plain paper or to any intermediate transfer medium. The adhesive transfer technique relies on the characteristics of liquid toners used in the electrophotographic process, the relative surface energies between the surface of the photoreceptor, the liquid toners, an intermediate transfer media and the “plain” paper, as well as certain temperatures and pressures. The two key considerations for adhesive (dry adhesive) transfer are heat (to raise the liquid ink to above its glass transition (T_{g}) temperature) and percentage of ink solids (how dry the toned image is). Generally, adhesive transfer processes encompass both direct transfer processes (toned image transfer is direct from the photoreceptive element to the final image receptor) and elastomeric transfer processes (toned images are transferred from a photoreceptive element to an elastomeric intermediate transfer member before being transferred to the final image receptor).

FIG. 1 shows an example of one preferred embodiment of a development unit positioning track 6 that may be mechanized in sliding or translating-type movement (such as is illustrated by arrow 7) to position each development unit (4a, 4b, 4c, 4d, or 4e) for contact with the photoreceptor 2, as desired. Movement of the track 6 may preferably allow for sequential positioning of the development units 4a-4e in a processing position relative to the photoreceptor 2, although it is not required that all development units be positioned in a processing position relative to the photoreceptor 2 for a particular image. Further, it is possible that a particular development unit be moved to its processing position more than once in the production of a single image. In addition, the order or sequence in which the development units 4a-4e contact the photoreceptor 2 does not necessarily require sequential use of adjacent development units (e.g., development unit 4b need not necessarily contact the photoreceptor immediately after development unit 4a). Rather, the positioning track 6 may be controlled so that nonadjacent development units may sequentially contact the photoreceptor 2, such that a single apparatus provides flexibility of the order in which the development units contact the photoreceptor 2. One example of a process using mechanized developer rollers is described in U.S. Pat. No. 5,434,591, the contents of which are incorporated herein by reference. However, a variety of systems and equipment may instead be used for movement of the development units in place of a sliding track system such as the development unit positioning track 6 of FIG. 1.

The liquid toner or transfer assist materials (not shown) provided within the development units 4a, 4b, 4c, 4d, and 4e preferably have a charge director and are attracted to the discharged regions of the photoreceptor 2 when the photoreceptor 2 contacts one of the development units. Once the photoreceptor 2, which may be coated with a release layer, has received the liquid toner layers and any transfer assist materials, the composite image may be transferred directly to a final image receptor 8 that is traveling in the direction of arrow 12. In adhesive transfer systems, the liquid toner is carefully formulated so that much of the liquid carrier rapidly evaporates or is removed from the image and the liquid toner (or toned image) forms a film on the surface of the photoreceptor. The liquid toned image on the photoreceptor 2 may be dried by a drying mechanism 17 (which is disclosed, for example, in U.S. Pat. No. 5,650,253, the entire contents of which are incorporated herein by reference) which may include an absorptive/adsorptive roller 15, vacuum box (not shown) or heat curing station (not shown). The drying mechanism 17 may be passive, may utilize active air blowers or may be other active devices such as absorbent rollers 15, as shown here. Such an apparatus is described in U.S. Pat. No. 5,420,675, for example, which is incorporated herein by reference. The drying mechanism 17 transforms liquid ink into a substantially dry ink film. The “solid” portion (ink film) that remains plated upon the surface of the photoreceptor 2 matches the previous image-wise charge distribution previously placed upon the surface of photoreceptor 2 and forms a developed electrostatic image. The toned image, which is now an ink film, representing the desired image to be printed, may then be transferred directly to the final image receptor 8. Transfer is affected by differential tack of the ink film and the photoreceptor surface 2. Typically, heat and pressure may be utilized to fuse the image to the final image receptor 8. The heat, the pressure, or both, that are necessary to facilitate transfer can be provided by a backup roller 10 that is not in contact with the photoreceptive element until the image is assembled and ready for transfer to the final receptor 8. When the image is ready for transfer, some type of signal causes the photoreceptive element 2, the backup roller 10, or both to move such that both are contacting the final image receptor 8 with sufficient pressure to facilitate transfer. The backup roller 10 may additionally be heated to encourage the image film to melt into the fibers of the final receptor 8.

One way this adhesive transfer process may be accomplished is by using a liquid toner that has a very low T_{g} that will form a film at room temperature. If a higher T_{g} ink formulation is used, the photoreceptor may be heated to cause the liquid carrier to evaporate and the image to film form. The backup roller 10 may also be heated. As the final image receptor 8 passes between the photoreceptor 2 (which may or may not be heated) and the heated backup roller 10, the toned image, which is now a film, is melted into the texture of the final image receptor 8. Because the photoreceptor 2 may be coated with a release layer, the toned image film should transfer relatively easily to the final image receptor 8. In any case, so long as the surface energy of the final image receptor 8 is greater than that of the photoreceptor 2, the image is likely to transfer. In electrophotographic systems that use adhesive transfer and do not use an intermediate transfer member (e.g., direct transfer is used), toner film thickness and compliance are important to successful transfer and quality images. This is especially true with respect to a final image receptor, such as plain paper, that is rough and has a relatively uneven surface.

One example of a liquid toner formulation for use in electrophotographic systems that use adhesive transfer is seen in U.S. Pat. No. 5,650,253. One type of ink found particularly suitable for use as liquid inks consists of ink materials that are substantially transparent and of low absorptivity to radiation from laser scanning devices. This allows radiation from laser scanning devices to pass through the previously deposited ink or inks and impinge on the surface of photoreceptor 2 and reduce the deposited charge. This type of ink permits subsequent imaging to be effected through previously developed ink images as when forming a second, third, or fourth color plane without consideration for the order of color deposition. It is preferable that the inks transmit at least 80% and more preferably 90% of radiation from the laser scanning devices and that the radiation is not significantly scattered by the deposited ink material of the liquid inks.

One type of ink found particularly suitable for use in this process are gel organosols which exhibit excellent imaging characteristics in liquid immersion development. For example, the gel organosol liquid inks exhibit low bulk conductivity, low free phase conductivity, low charge/mass and adequate mobility, which are all desirable characteristics for producing high resolution, background free images with high optical density. In particular, the low bulk conductivity, low free phase conductivity and low charge/mass of the inks allow them to achieve high developed optical density over a wide range of solids concentrations, thus improving their extended printing performance relative to conventional inks.

These color liquid inks, upon development, form colored films that transmit incident radiation such as, for example, near infrared radiation, consequently allowing the photoconductor layer to discharge, while non-coalescent particles scatter a portion of the incident light. Non-coalesced ink particles therefore result in the decreasing of the sensitivity of the photoconductor to subsequent exposures and consequently there is interference with the overprinted image.

These inks preferably have relatively low T_{g} values that enable the inks to form films at room temperature. In these cases, normal room temperature (19° C.-23° C.) is sufficient to enable film forming and the ambient internal temperatures of the apparatus during operation, which tends to be at a higher temperature (e.g., 25° C.-40° C.) even without specific heating elements, is sufficient to cause the ink or allow the ink to form a film.

Residual image tack after transfer may be adversely affected by the presence of high tack monomers, such as ethyl acrylate, in the organosol. Therefore, the organosols are generally formulated such that the organosol core preferably has a glass transition temperature (T_{g}) less than room temperature (25° C.) but greater than −10° C. A preferred organosol core composition contains about 75 weight percent ethyl acrylate and 25 weight percent methyl methacrylate, yielding a calculated core T_{g} of about −1° C. This permits the inks to rapidly self-fix under normal room temperature or higher development conditions and also produce tack-free fixed images which resist blocking.

The carrier liquid may be selected from a wide variety of materials which are well known in the art. The carrier liquid is typically oleophilic, chemically stable under a variety of conditions, and electrically insulating. Electrically insulating means that the carrier liquid has a low dielectric constant and a high electrical resistivity. Preferably, the carrier liquid has a dielectric constant of less than 5, and still more preferably less than 3. Examples of suitable carrier liquids are aliphatic hydrocarbons (n-pentane, hexane, heptane and the like), cycloaliphatic hydrocarbons (cyclopentane, cyclohexane and the like), aromatic hydrocarbons (benzene, toluene, xylene and the like), halogenated hydrocarbon solvents (chlorinated alkanes, fluorinated alkanes, chlorofluorocarbons and the like), silicone oils and blends of these solvents. Preferred carrier liquids include paraffinic solvent blends sold under the names Isopar™ G liquid, Isopar™ H liquid, Isopar™ K liquid, Isopar™ L liquid, Norpar™ 13 liquid and Norpar™ 15 liquid (manufactured by Exxon Chemical Corporation, Houston, Tex.). The preferred carrier liquid is Norpar™ 12 liquid, also available from Exxon Corporation.

The toner particles used in the liquid inks are preferably comprised of colorant embedded in a thermoplastic resin. The colorant may be a dye or more preferably a pigment. The resin may be comprised of one or more polymers or copolymers that are characterized as being generally insoluble or only slightly soluble in the carrier liquid; these polymers or copolymers comprise a resin core. In addition, superior stability of the dispersed toner particles with respect to aggregation is obtained when at least one of the polymers or copolymers (denoted as the stabilizer) is an amphipathic substance containing at least one chain-like component of molecular weight at least 500 which is solvated by the carrier liquid. Under such conditions, the stabilizer extends from the resin core into the carrier liquid, acting as a steric stabilizer as discussed in Dispersion Polymerization (Ed. Barrett, Interscience., p. 9 (1975)). Preferably, the stabilizer is chemically incorporated into the resin core, i.e., covalently bonded or grafted to the core, but may alternatively be physically or chemically adsorbed to the core such that it remains as an integral part of the resin core.

The composition of the resin is preferentially manipulated such that the organosol exhibits an effective glass transition temperature (T_{g}) of less than 25° C. (more preferably less than 6° C.), thus causing an ink composition of liquid inks containing the resin as a major component to undergo rapid film formation (rapid self fixing) in printing or imaging processes carried out at temperatures greater than the core T_{g} (preferably at or above 25° C.). The use of low T_{g} resins to promote rapid self fixing of printed or toned images is known in the art, as exemplified by Film Formation (Z. W. Wicks, Federation of Societies for Coatings Technologies, p. 8 (1986)). Rapid self-fixing is thought to avoid printing defects (such as smearing or trailing-edge tailing) and incomplete transfer in high-speed printing. For printing on plain paper, it is preferred that the core T_{g} be greater than −10° C. and, more preferably, be in the range from −5° C. to 5° C. so that the final image is not tacky and has good blocking resistance.

Such rapid self fixing is required of liquid inks to enable the liquid inks applied first in the process to film form before being subjected to overlay by a subsequent liquid ink in the formation of a subsequent color plane of the image. It is preferred that liquid inks self fix within about 0.5 seconds to enable the apparatus to operate at sufficient speed and to ensure image quality. Such rapid self-fixing will generally occur in liquid inks which have greater than 75 percent volume fraction of solids in the image.

It is also preferred that the glass transition temperature (T_{g}) of the liquid inks be greater than −10° C. and less than 25° C. so that the final image is not tacky and has good blocking resistance. More preferred is a T_{g} between −5° C. and 5° C.

It is also preferred that the liquid inks have a low charge to mass ratio which assists in giving the resultant image high density. It is preferred that liquid inks have a charge to mass ratio of from 0.025 to 0.1 microcoulombs/(centimeters²-OD). Liquid inks have a charge to mass ratio of from 0.05 to 0.075 microcoulombs/(centimeters²-OD) in the most preferred embodiment. This is the charge per developed optical density, which is directly proportional to charge per mass.

It is also preferred that the liquid inks have a low free phase conductivity which aids in providing high resolution, gives good sharpness and low background. It is preferred that the free phase conductivity is less than 30 percent at 1 percent solids. It is still more preferred that the free phase conductivity is less than 20 percent at 1 percent solids. A free phase conductivity of less than 10 percent at 1 percent solids is most preferred.

Examples of resin materials suitable for use in the liquid inks include polymers and copolymers of (meth)acrylic esters; including methyl acrylate, ethyl acrylate, butyl acrylate, ethylhexyl acrylate, 2-ethylhexylmethacrylate, lauryl acrylate, octadecyl acrylate, methyl methacrylate, ethyl methacrylate, lauryl methacrylate, 2-hydroxy ethyl methacrylate, octadecyl methacrylate and other polyacrylates. Other polymers may be used in conjunction with the aforementioned materials, including melamine and melamine formaldehyde resins, phenol formaldehyde resins, epoxy resins, polyester resins, styrene and styrene/acrylic copolymers, acrylic and methacrylic esters, cellulose acetate and cellulose acetate-butyrate copolymers, and poly(vinyl butyral) copolymers.

The colorants which may be used in the liquid inks include virtually any dyes, stains or pigments which may be incorporated into the polymer resin, which are compatible with the carrier liquid, and which are useful and effective in making visible the latent electrostatic image. Examples of suitable colorants include: Phthalocyanine blue (C.I. Pigment Blue 15 and 16), Quinacridone magenta (C.I. Pigment Red 122, 192, 202 and 206), Rhodamine YS (C.I. Pigment Red 81), diarylide (benzidine) yellow (C.I. Pigment Yellow 12, 13, 14, 17, 55, 83 and 155) and arylamide (Hansa) yellow (C.I. Pigment Yellow 1, 3, 10, 73, 74, 97, 105 and 111); organic dyes, and black materials such as finely divided carbon and the like.

The optimal weight ratio of resin to colorant in the toner particles is on the order of 1/1 to 20/1, most preferably between 10/1 and 3/1. The total dispersed “solid” material in the carrier liquid preferably represents 0.5 to 20 weight percent, most preferably between 1 and 5 weight percent of the total liquid developer composition.

The liquid inks include a soluble charge control agent, sometimes referred to as a charge director, to provide uniform charge polarity of the toner particles. The charge director may be incorporated into the toner particles, may be chemically reacted to the toner particle, may be chemically or physically adsorbed onto the toner particle (resin or pigment), and may be chelated to a functional group incorporated into the toner particle, preferably via a functional group comprising the stabilizer. The charge director acts to impart an electrical charge of selected polarity (either positive or negative) to the toner particles. Any number of charge directors described in the art may be used herein; preferred positive charge directors are the metallic soaps (see U.S. Pat. No. 3,411,936, Rotsman et al.). The preferred charge directors are polyvalent metal soaps of zirconium and aluminum, preferably zirconium octoate.

In accordance with the present invention, the liquid inks described herein may have a tendency to exhibit cohesive weakness with respect to the ink film, or adhesive weakness with respect to the final image receptor, or may tend to adhere to the various rollers of the apparatus, which is generally undesirable. Thus, it is advantageous to use a transfer assist layer to minimize the chances of such behavior of the liquid inks. This transfer assist layer may consist of a wide variety of materials, such as for example, the transfer assist material may be an organosol of the type described above; however, the organosol layer would then preferably not include any pigment (i.e., nonpigmented organosol). The transfer assist material may or may not include a charge director, as described below. In addition, the transfer assist material may have the same glass transition temperature as the inks that are used in the same apparatus so that the transfer assist material will film form as part of the complete layer that includes the ink materials. The transfer assist material may alternatively have a different glass transition temperature than that of the inks. For one example, the transfer assist material may have a glass transition temperature that is higher than that of the ink layers so that the transfer assist material will not film form to the same extent as the ink layers. In this case, the layers may be less likely to completely release from the various rollers, although it may be desirable in such cases to add various release agents to the transfer assist layer material.

In accordance with the present invention, at least one of the development units 4a-4e contains a transfer assist material for application to the photoreceptor 2 in a variety of different sequential processes, as will be described below. A transfer assist material in this type of apparatus may be a colorless liquid such as an unpigmented liquid toner or an organosol (which is the basis of the pigmented liquid toner described above) that may or may not contain a charge director. The inclusion of the charge director will enable the transfer assist material to transfer by charge exchange to the area to be imaged (or that is already imaged) on the photoreceptor 2 and to the final receptor 8. In this process, because the liquid toner development units 4a, 4b, 4c, 4d, 4e are positioned to contact the photoreceptor 2 as needed, the transfer assist material may be placed in any of the development units. This multi-pass system thus provides the advantage of being relatively flexible in the application of multiple layers in various sequences, which sequences may be changed by reprogramming computer instructions, for example.

The other developer units of a particular electrophotographic apparatus preferably contain the colors cyan (C), magenta (M), yellow (Y), and black (K), but the colors in each developer unit may include any color including, for example, a red (R), green (G), blue (B), and black (K) system, or other variations. In accordance with the present invention, it is understood that any toner layer or image may include one or more colors or layers, but such layers and images are generally shown and described herein as a single toner layer, for clarity of description and illustration. Computer signals may then govern at what point the transfer assist material is applied to the photoreceptor 2. The transfer assist material may be applied to the photoreceptor 2 before the colored toners are applied, or over the toned image; both are described below.

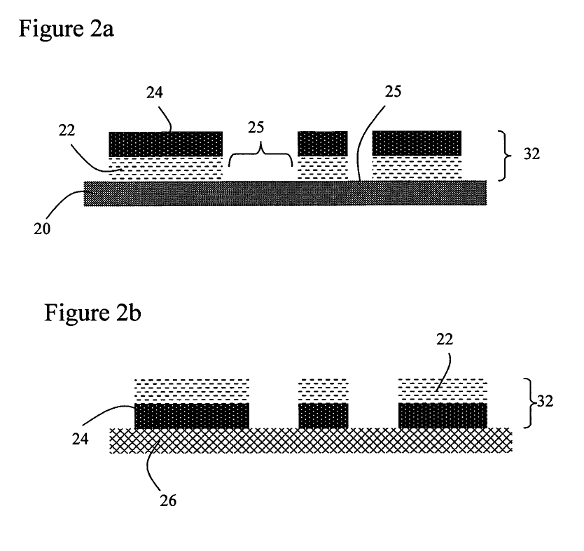

FIG. 2a shows a transfer assist layer 22 as applied or positioned on a photoreceptor 20, such as could be applied by an apparatus such as apparatus 1 of FIG. 1. A toner layer 24, which may include one or more colors applied in any desired sequence, is applied or positioned so that it at least partially covers the transfer assist layer 22. FIG. 2b illustrates the arrangement of the layers of FIG. 2a in its configuration after the image is transferred to a final image receptor 26. When the transfer assist layer 22 is placed on the photoreceptor 20 before the toner layer or layers 24, as in this embodiment, transfer of the image to the final receptor 26 places the toner layer 24 in direct contact with the final receptor 26 and places the transfer assist layer 22 on the outside. Any of the various combinations of a transfer assist layer or layers 22 and the toner layer, or layers (i.e., a composite layer) 24 are described herein as a composite, complete, or total image layer 32.

The schematic of FIG. 2a shows a preferred embodiment where the transfer assist material 22 comprises charged particles and has been, for example, electrophoretically developed to select portions of the photoreceptive element 20. The at least one pigmented toner layer 24 is subsequently electrophoretically developed over the transfer assist material 22. Areas that will not receive any pigment toner 25 also do not receive any transfer assist material.

When the transfer assist layer 22 is applied to the photoreceptor 20 before the toner layer or layers 24 in this way, the layer 22 may provide any of several advantages. In electrophotographic apparatuses that use adhesive transfer processes, the pigmented toner particle size is not critical, except as an image resolution factor. Because the toner particles coalesce into a cohesive film, the individual particle size does not substantially affect transfer. However, particle size may be constrained simply because smaller toner particles (sub-micron) tend to produce higher resolution images. Because the transfer assist material is a non-pigmented, film-forming liquid ink, it may bond cohesively with the pigmented ink layers to promote cohesion, thereby assisting in transfer.

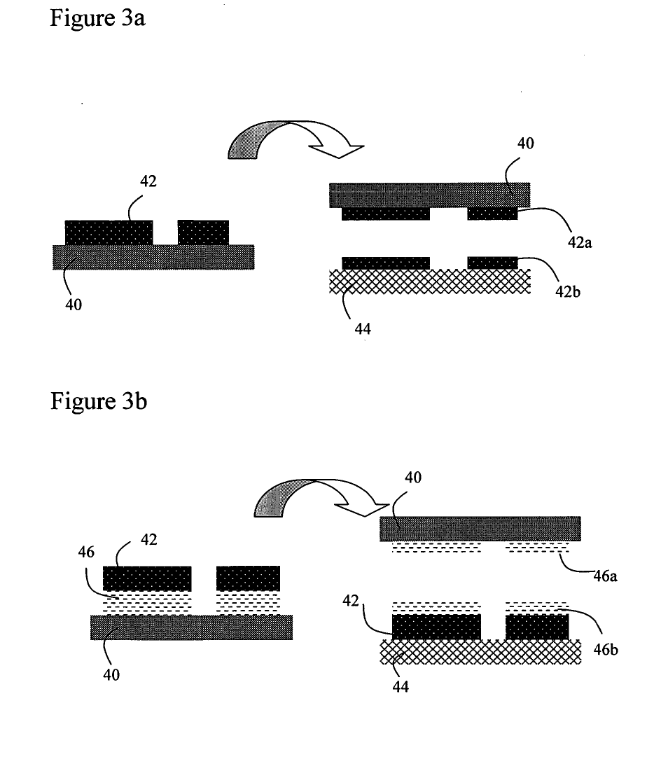

FIGS. 2a and 2b illustrate how a transfer assist layer may be incorporated to provide complete release from a photoreceptor, but complete (100%) transfer may not be necessary when a transfer assist layer is used. In FIGS. 3a and 3b, for example, the transfers of an image with and without a transfer assist layer are illustrated, where FIG. 3b shows the use of a transfer assist layer as a “sacrificial layer”. First, in FIG. 3a, a photoreceptor 40 is shown having a toned image (toner film) 42 thereon. As indicated by the arrow, the second step of this process shows transfer of that image to a final receptor 44 in which the entire toner film 42 does not transfer. This figure shows that if there is incomplete toner transfer, only a portion of the toner film 42 is transferred to the final receptor 44 and is shown as a layer 42b (a partial layer). The portion 42a that remains behind on the photoreceptor 40 is toner that contributed to the quality and optical density of the image. The result can be an image on a final substrate having diminished optical quality and a “papery” or mottled appearance due to the presence of scattered microvoids or small patches of missing toner in the image. A similar problem that is not illustrated here, is where a portion of the film formed image transfers at 100% while one or more portions transfer at 0%, leaving holes or voids in the image film on the final substrate.

FIG. 3b shows the same phenomenon as shown in FIG. 3a, but with the use of a transfer assist layer. In accordance with the present invention, a photoreceptor 40 with a layer of transfer assist material 46 and a toner film 42 is provided. As indicated by the arrow, the second step of this process occurs when it is desired to transfer the image to the final substrate. As shown in this figure, the transfer assist layer 46 may or may not form a film, but “splits” or divides in such a way that a portion of the transfer assist layer 46b goes with the toner film 42 to the final image receptor 44, and a portion of the transfer assist layer 46a remains behind on the photoreceptor 40. Advantageously, the entire toner image layer 42 is thereby transferred to the final image receptor 44, thereby assisting in maintaining a desirable optical density of the image or the cohesive strength of the toner film. A preferred transfer assist material composition in this embodiment may have a higher glass transition temperature (i.e. above 40° C.) so as not to form a film.

However, one advantage that a transfer assist layer may have is as a release layer, with some or all of the transfer assist layer transferring to the final image receptor 26 with the pigmented toner particles of the final image. One way this may be accomplished is by using an organosol to create a transfer assist layer that ha a higher T_{g}. than the liquid ink. The higher T_{g} layer would provide release from the photoreceptor surface, while promoting cohesion among the toner particles of the image, as they film form before transfer. Some examples of transfer assist materials that can be used for release and may be incorporated into a higher T_{g} organosol include silicone macromers and polydimethylsiloxanes. U.S. Pat. Nos. 5,521,271, 5,604,070, and 5,919,866 provide lists of examples of polymeric dispersions that include surface release promoting moieties, and all of these references are incorporated herein by reference.

This process may have additional advantages not related to transfer assistance. For example, a transfer assist layer may have additives to make it a durable image protectant when the image is fixed or fused to the final receptor. Examples of such additives include organosols that incorporate high T_{g} monomers, such as TCHMA, isobornylacrylate, or isobornylmethacrylate, (as is described, for example, in co-pending U.S. patent application of the present Assignee, Ser. No. 10/612,765, filed Jun. 30, 2003, entitled “ORGANOSOL INCLUDING HIGH TG AMPHIPATHIC COPOLYMERIC BINDER AND LIQUID TONERS FOR ELECTROPHOTOGRAPHIC APPLICATIONS” (Attorney Docket No. SAM0005/US), the entire content of which is incorporated herein by reference, or that incorporate covalently bonded polymerizable, crystallizable monomers such as acrylates or methacrylates with carbon numbers including and between C₁₆ and C₂₆ (e.g., hexadecyl-acrylate or -methacrylate, stearyl-acrylate or -methacrylate, or behenyl-acrylate or -methacrylate) (as is described, for example, in co-pending U.S. patent application of the present Assignee Ser. No. 10/612,534, filed Jun. 30, 2003, entitled “ORGANOSOL LIQUID TONER INCLUDING AMPHIPATHIC COPOLYMERIC BINDER HAVING CRYSTALLINE COMPONENT” (Attorney Docket No. SAM0004/US), the entire content of which is incorporated herein by reference). The transfer assist layer can also be adjusted to have properties that, for example, offer abrasion resistance or protection from ultraviolet radiation. It can also be modified to provide a glossy surface, enhancing the way the image looks on the final receptor. These features are not requirements of an effective transfer assist layer, but they could be elements of an enhanced transfer assist layer that solves other imaging problems or defects.

As discussed above with respect to FIG. 1, the transfer assist material may be placed in any development unit position (4a, 4b, 4c, 4d, or 4e) for plating to the photoreceptor 2. However, the embodiments described above include processes in which the development unit containing the transfer assist material applies the transfer assist material to the photoreceptor prior to the application of any toner materials. The transfer assist material may instead be applied to the photoreceptor 2 after the toned image is layered on the photoreceptor, as described below.

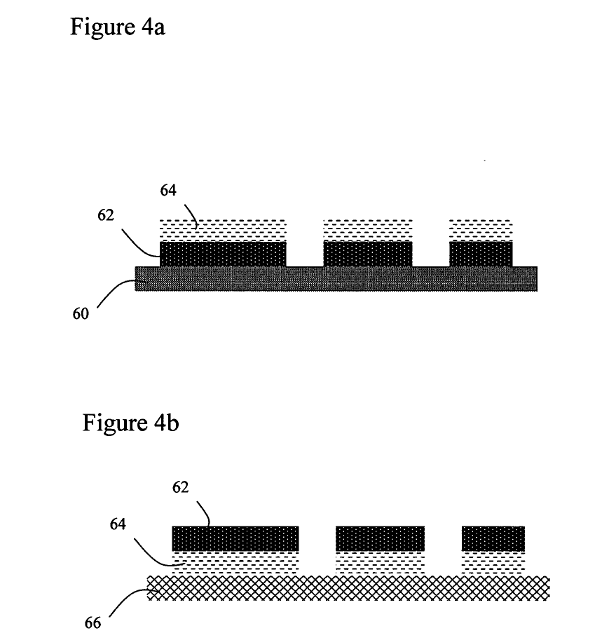

FIGS. 4a and 4b illustrate another embodiment of the present invention in which the layers and the transfer steps are shown for a process wherein a transfer assist layer is initially placed over the toned image. In particular, FIG. 4a shows a photoreceptor 60, with a complete toned image positioned thereon made up of at least one toner film 62 and a transfer assist layer 64 at least partially covering the toner film/layer 62. When the image is then transferred to the final receptor 66 (as shown in FIG. 4b), the transfer assist layer 64 contacts the final image receptor 66 and the toner film 62 is on the outside (i.e., the toner film 62 is the top layer).

This embodiment of FIGS. 4a and 4b illustrates the improved transfer efficiency that may be achieved through the use of a transfer assist layer in this position. In particular, this transfer efficiency may be enhanced due to properties of the transfer assist layer that enhance the cohesive strength of the toner film 62 and the adhesive strength of the ink film 62 to the final receptor 66. One way this can work is by choosing a transfer assist material that incorporates high surface energy or polar monomers such as amino functional acrylates as discussed in co-pending U.S. patent application Ser. Nos. 10/013,635 and 10/334,398. A transfer assist layer used in this way does not necessarily promote transfer efficiency by providing a layer for release or splitting from the photoreceptor. However, in this embodiment, the transfer assist layer can be used as an adhesive to bond the ink film to the final image receptor, thereby creating stronger cohesive strength within the final image and better adhesion to the final image substrate. One way this may be achieved is by the use of a transfer assist layer having a very low T_{g} of −1° C. or less. Additionally, this embodiment might be particularly useful with respect to the printing of liquid toners on overhead projection film (OHP film), for example.

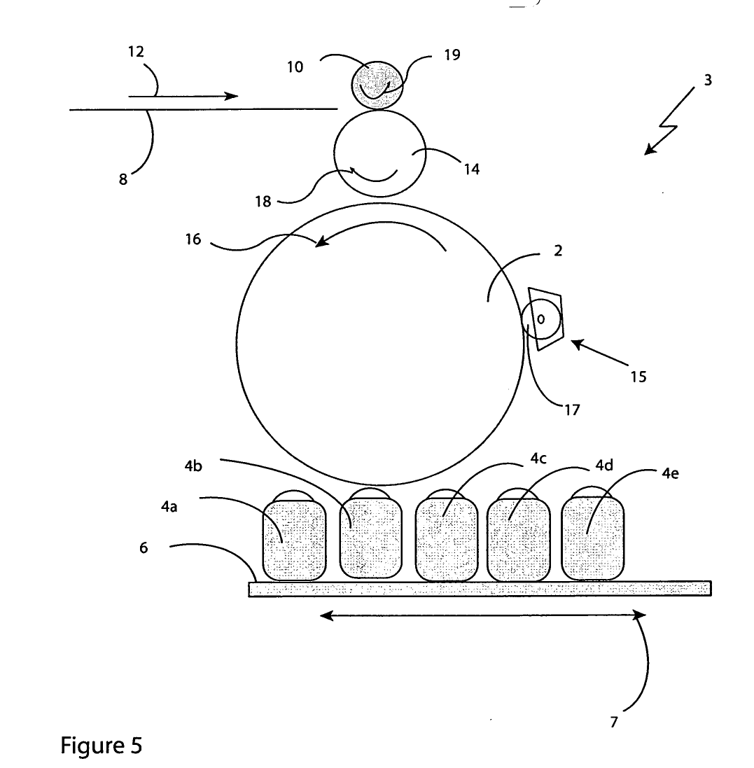

FIG. 5 shows another embodiment of an electrophotographic apparatus 3 in accordance with the present invention, which is similar to the apparatus of FIG. 1. The apparatus 3 additionally incorporates the use of an intermediate transfer member 14 positioned between a photoreceptor 2 and a backup roller 10. A photoreceptor 2 is included in the electrophotographic apparatus 3 and is positioned so that multiple development units 4a, 4b, 4c, 4d, and 4e can be moved into place against the photoreceptor 2 as needed. While five development units are provided in this embodiment, more or less than five development units may be provided for a particular electrophotographic apparatus. These units may comprise at least one development unit containing toner and at least one development unit containing transfer assist material. The photoreceptor 2 is shown in this non-limiting example as a drum, but may instead be a belt, a sheet, or some other photoreceptor configuration As with the apparatus 1 of FIG. 1, one preferred embodiment of a development unit in the apparatus 3 of FIG. 5 includes a positioning track 6 that may be mechanized in sliding or translating-type movement (such as is illustrated by arrow 7) to position each development unit (4a, 4b, 4c, 4d, or 4e) in its processing position for contact with the photoreceptor 2, as desired. It is understood, however, that the photoreceptor may instead be moveable to establish the processing position of the photoreceptor relative to one or more development units, or that both the photoreceptor and development units may be moveable relative to each other.

Movement of the track 6 or other mechanism used for positioning of development units may preferably allow for sequential contact of the development units 4a-4e with the photoreceptor 2, although it is not required that all development units contact the photoreceptor 2 for a particular image. Further, it is possible that a particular development unit or multiple development units contact the photoreceptor 2 more than once in the production of a single image. In addition, the order or sequence in which the development units 4a-4e contact the photoreceptor 2 does not necessarily require sequential use of adjacent development units (e.g., development unit 4b need not necessarily contact the photoreceptor immediately after development unit 4a). Rather, the positioning track 6 may be controlled so that nonadjacent development units may sequentially contact the photoreceptor 2, such that a single apparatus provides flexibility of the order in which the development units contact the photoreceptor 2. Once the desired number of toner layers are applied to the photoreceptor 2 by the various development units, the intermediate transfer member 14 may be moved against the photoreceptor 2, using any preferred movement mechanisms.

Referring to FIG. 5, the “solid” color pigments of the liquid inks preferably form a film with sufficient cohesive strength on the surface of photoreceptor 2 before or during transfer to intermediate transfer member 14. The image consisting of a cohesive film comprised of as many as four layers of the “solid” color pigments of the liquid inks can be formed into a substantially dry film by using, for example, a drying roller 15 or other drying device 17. Preferably, the drying roller 15 is a silicone-coated roller that absorbs any remaining liquid. The purpose of the drying station or device 17 is to further dry, or “condition,” the image for subsequent transfer, and may alternatively use a conventional hot air blower or any other conventional means.

The composite image is then transferred in a single step to an intermediate transfer member 14 for subsequent transfer to the final image receptor 8. A signal activates either the photoreceptor 2 or the intermediate transfer member 14 or both to move into a position that will allow the composite image on the surface of the photoreceptor 2 to be brought into pressure contact with intermediate transfer member 14 that is constructed of an elastomer, preferably fluorosilicone, heated to temperature T1. Temperature T1 can be in the range of 25° C. to 130° C., more preferably from 50° C. to 100° C., and most preferably about 90° C. At temperature T1, a tack develops between the elastomer of the intermediate transfer member or member 14 and the liquid ink film. Although a roller is preferred for the intermediate transfer member 14, a belt is also envisioned. In one example, the preferred force for contact between the intermediate transfer member 14 and photoreceptor 2 is 70 pounds (32 kilograms) or, alternatively, 56 pounds per square inch (4 kilograms per square centimeter) if the nip area is 1.25 square inches (8 square centimeters). The composite liquid ink image preferably adheres to the elastomer of the intermediate transfer member 14 when the photoreceptor 2 and the elastomer surface of the intermediate transfer member 14 are separated. The surface of photoreceptor 2 preferably releases the liquid ink image.

It is believed that the pressure contact between the intermediate transfer member 14 and photoreceptor 2 enhances the dwell time during which the composite image is in contact with both the intermediate transfer member 14 and the surface of the photoreceptor 2. It is preferred that the materials and diameters of the intermediate transfer member 14 and photoreceptor 2 and the force between them be selected such that the dwell time is at least 25 milliseconds and, preferably, approximately 52 milliseconds.

The elastomer of the intermediate transfer member 14 preferably has sufficient adhesive properties at temperature T1 to pick up the semi-dry liquid ink image from the surface of the photoreceptor 2. Further, the elastomer of the intermediate transfer member 14 preferably has sufficient release properties at temperature T2 to allow the film-formed liquid ink image to be released to the final image receptor 8. The elastomer of the intermediate transfer member 14 is also preferably able to conform to the irregularities in the surface of the final image receptor 8, e.g. the irregularities of rough paper. Conformability is accomplished by using an elastomer having a Shore A Durometer hardness of about 65 or less, preferably 50. In addition, the elastomer should preferably be resistant to swelling and attack by the carrier medium, e.g., hydrocarbon, for liquid inks. The elastomer of the intermediate transfer member 14 has an adhesive characteristic relative to liquid film forming inks that is greater than the adhesive characteristic of the liquid inks and release surface of photoreceptor 2 at temperature T1, but less than the adhesive characteristic of the liquid inks and the final image receptor 8 at temperature T2. The choice of the elastomer of the intermediate transfer member 14 is dependent on the release surface of photoreceptor 2, the composition of the liquid inks, final image receptor 8. For the process described here, several fluorosilicone elastomers meet these requirements, e.g., Dow Corning 94003 fluorosilicone dispersion coating, available from Dow Corning Corporation, Midland, Mich.

Subsequently, the composite liquid ink image adhered to intermediate transfer member 14 can be brought in pressure contact with the final image receptor 8 (e.g. plain paper) at temperature T2 through a nip created with backup roller 10. Temperature T2 ranges from not nominally above room temperature to around 100° C. In one embodiment, the temperature T2 is not critical. Heating for this image transfer step is substantially provided by the already heated intermediate transfer member 14. No additional heat is believed necessary to facilitate transfer between the intermediate transfer member 14 and the final image receptor 8. However, it is also believed desirable that the backup roller 10 be heated to approximately 40° C. to prevent the backup roller 10 from sucking or absorbing a significant amount of heat from the intermediate transfer member 14. For this same reason, the final image receptor 8 may be preheated to around 35° C. before transfer is attempted from the intermediate transfer member 14 to the final image receptor 8. If desired, however, T2 can be in the range of 70° C. to 150° C. and preferably is about 115° C. Under an applied force of preferably around one-half to two-thirds of the force between the intermediate transfer member 14 and the photoreceptor 2, preferably around 95 pounds per square inch (35 kilograms per square centimeter), the composite liquid ink image bearing elastomer of the intermediate transfer member 14, preferably a rigid metal roller, conforms to the topography of the final image receptor 8 so that every part of the composite liquid ink image, including small dots, can come into contact with the surface of the final image receptor 8 and transfer to the final image receptor 8.

The elastomeric transfer technique relies on a relative surface energy hierarchy among the surface of the photoreceptor 2, the intermediate transfer member 14, the toner particles comprising the liquid inks and the final image receptor 8. Preferably, application of the transfer assist material to the photoreceptor surface should provide an imaging surface having an apparent surface energy less than the surface energy of the intermediate transfer member 14. Further, the surface energy of the intermediate transfer member 14 should be less than the respective surface energies of the liquid inks, and the surface energy of the final image receptor 8 should be greater than the surface energy of the intermediate transfer member. If a contact drying means is used, the surface of the contact drying means is preferably capable of absorbing carrier liquid, but must have a surface energy less than that of the photoreceptor surface. This relative hierarchy of surface energies helps ensure a reliable and sequential transfer of the composite multi-color image during elastomeric transfer.

In some embodiments, it is preferred that the surface energy of the photoreceptor 2 be at least 0.5 dyne per centimeter less than the surface energy of the intermediate transfer member 14. Most preferred is that the surface energy of photoreceptor 2 be at least 1.0 dyne per centimeter less than the surface energy of the intermediate transfer member 14. It is also preferred that the surface energy of the intermediate transfer member 14 be at least 2.0 dyne per centimeter less than the surface energy of the liquid inks. Most preferred is that the surface energy of intermediate transfer member 14 be at least 4.0 dyne per centimeter less than the surface energy of the liquid inks.

Surprisingly, in some embodiments, the application of a suitable low surface energy transfer assist material to a photoreceptor surface before development of the liquid toned image permits the use of a photoreceptor having a surface energy greater than that of the intermediate transfer member in an elastomeric toner transfer process. This is advantageous in permitting the use of a wider variety of high surface energy photoreceptors, particularly photoreceptors not having surface release layers or inherent surface releasibility, in adhesive or elastomeric transfer imaging processes. The use of a transfer material to provide a renewable release surface release to the photoreceptor also increases the useful life of the photoreceptor without concern regarding the build-up of high surface energy residues which can degrade elastomeric transfer performance of the liquid toned images.

Any conventionally known photoreceptor may be employed with a suitable low surface energy transfer assist material according to the present invention. However, the photoreceptor surface preferably does not exhibit a surface release character prior to application of the transfer material. Most preferably, the adhesive strength of the photoreceptor surface is greater than 150 grams-force before application of the transfer material, as measured according to JIS Z 0237-1980, “Testing Methods of Pressure Sensitive Adhesive Tapes and Sheets,” as described in U.S. Pat. No. 5,689,785 at column 5, lines 10-52, the disclosure of which is incorporated herein by reference.

In some embodiments of the present invention, the surface energy of the transfer material ranges from around 24 dyne per centimeter to around 26 dynes per centimeter, the surface energy of the intermediate transfer member 14 ranges from around 26 dynes per centimeter to around 28 dynes per centimeter, the surface energy of the photoreceptor surface exceeds 26 dynes per centimeter, the surface energy of the developed liquid toned images ranges from around 30 dynes per centimeter to around 40 dynes per centimeter, and the surface energies for final image receptors 8 range from around 40 dynes per centimeter for plain paper to around 42 dynes per centimeter for overhead projection transparency film. All surface energies discussed herein are measured in dynes per centimeter at approximately room temperature, preferably at around 20° C. to 23° C.

The key to use of a high surface energy photoreceptor in an adhesive or elastomeric transfer imaging process lies in the ability of the transfer material to present a release surface to the liquid toned images subsequently developed on the photoreceptor. However, it would be unnecessarily wasteful to apply the low surface energy transfer material to the photoreceptor surface in areas where no liquid toner particles will be subsequently deposited to develop a toned image. Accordingly, in a preferred embodiment, the transfer material is applied to the photoreceptor surface by known liquid electrophotographic methods in an imagewise manner corresponding to the sum of the image data used to produce each subsequent toned image, as shown schematically in FIGS. 2a, 3b, 4a, 6a and 7a. Preferably, the transfer assist material comprises charged particles of low surface energy transfer material dispersed in a carrier liquid suitable for use in liquid electrophotographic toners as described above. Although any suitable carrier liquid may be used to disperse the charged particles of transfer material, preferably, the carrier liquid is selected to comprise the same chemical materials that are used as the carrier liquid for the subsequently developed liquid toners.

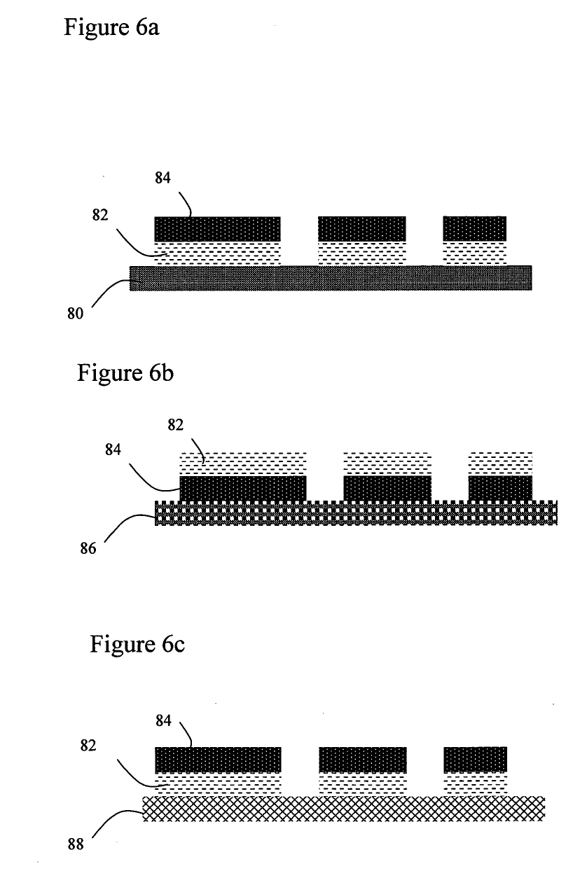

As discussed relative to FIG. 1, a transfer assist layer may be applied either before or after the application of a liquid toner on the photoreceptor. When such a transfer assist layer is used, it may be placed in any developer position because the mechanisms and/or software that control the movement of development units to contact the photoreceptor can control the timing of the application of the transfer assist material. In another embodiment of the present invention, FIG. 6a shows a first step of an electrophotographic process using equipment similar to that shown in FIG. 5. In FIG. 6a, a transfer assist layer 82 is first applied to a photoreceptor 80, then a film-forming toner layer 84 comprising one or more colors is applied on top of the transfer assist layer 82. When the toner accumulation is complete, the complete or composite image may then be transferred to an intermediate transfer member 86, as shown schematically in FIG. 6b. In this step, the toner film 84 is transferred to the intermediate transfer member 86, and the transfer assist layer 82 is then “on top” of the layers. A final step of this process is illustrated in FIG. 6c, in which the image is transferred to the final receptor or substrate 88. This results in the transfer assist layer 82 being positioned between the final receptor 88 and the toner film 84, with the toner layer 84 “on top.”

In this embodiment of the process (i.e., using an intermediate transfer member), the transfer assist layer can function either as a release layer as described for FIGS. 2a and 2b, or as a “sacrificial layer” that can split as described for FIG. 3b. Even though the photoreceptor of this invention may have a release coating, the use of a consumable transfer assist layer can prolong the life of the release layer, or prolong the life of the photoreceptor if the release layer is damaged, enhance the functionality of the photoreceptor release layer, or provide a consumable substitute for a permanent photoreceptor release layer. These functions of the transfer assist layer are primarily determined by the position of this layer relative to the photoreceptor and toner layers. In one aspect, the transfer assist layer shown as layer 82 in FIGS. 6a through 6c may be partially left on the photoreceptor 80 (not shown) in the transfer to the intermediate transfer member 86. In this embodiment, the transfer assist layer 82 in FIG. 6b may be less thick than the initial transfer assist layer 82 of FIG. 6a. The transfer assist layer 82 can also function as described relative to FIG. 4, improving transfer by chemical and physical bonding with the toner film 84 (i.e., the transfer assist layer film forms with the toner film) and encouraging adhesion to the final receptor 88. Additionally, all of the additional benefits and properties discussed above that are unrelated to the actual transfer performance and that may be included in the transfer assist layer (including abrasion and UV protection and adhesion promotion, for example) may also be included within the scope of this embodiment.

In yet another embodiment of the present invention, the layers shown in FIG. 6a could alternatively include only the toner layer 84 applied on the photoreceptor 80 (i.e., the transfer assist layer 82 would not be applied in this step). Instead, the transfer assist layer 82 could be initially applied over at least a portion of the toner layer 84 after it has been transferred to the intermediate transfer member 86 in FIG. 6b. Although not particularly illustrated in FIG. 5, a larger intermediate transfer member could be used to provide enough space for a cartridge and applicator to meter the transfer assist layer 82 on top of the final toned image on the intermediate transfer member. In this embodiment, the transfer assist material may or may not be film forming, and would not need a charge director component, because the electrophoretic application step is omitted. Instead, the transfer assist layer 82 could be applied over the toner film 84 on the ITM 86 by means of a metering or application roller, dispenser, brush, or spray. In this embodiment, the transfer assist material would not need to be transparent to the radiation used to discharge the photoreceptor.

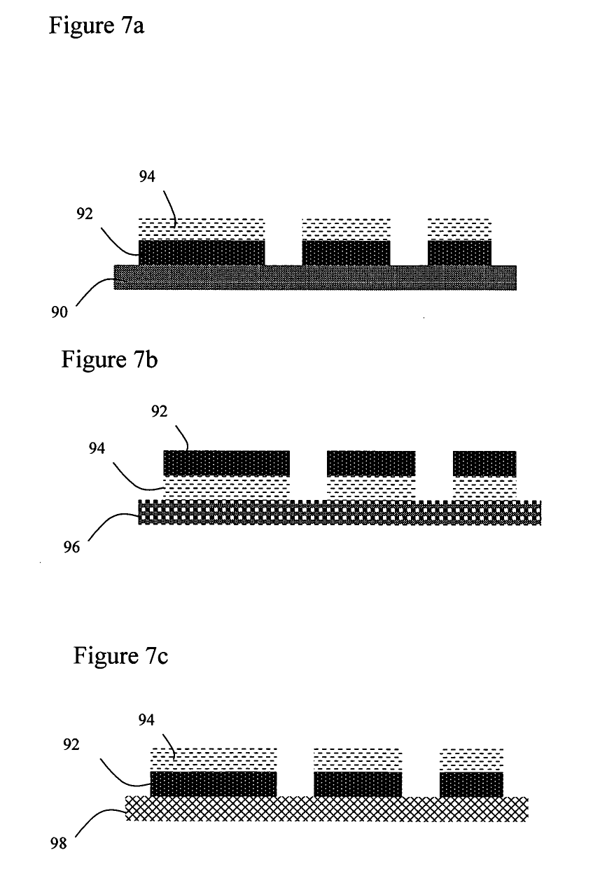

FIGS. 7a-7c illustrate the transfer steps and layer arrangement for a process using an intermediate transfer member, where the transfer assist layer is placed on the photoreceptor after the toned image is completely formed. As shown in FIG. 7a, a toner layer 92 is applied to or positioned on a photoreceptor 90, with a transfer assist layer 94 applied over the top of the toned image film 92. In the next step of the process, shown in FIG. 7b, the image is transferred to the intermediate transfer member 96, leaving the transfer assist layer 94 in contact with the intermediate transfer member 96 and the toner film 92 exposed. A final step in this process is shown in FIG. 7c, in which the image is transferred to a final receptor 98, so that the toner layer 92 is in contact with the receptor 98 and the transfer assist layer 94 is exposed.

This embodiment advantageously utilizes the ability of the transfer assist layer 94 to act as a release or sacrificial layer from the intermediate transfer member 96, where such advantages of this layer are similar to those described above relative to FIGS. 2 and 3. Similarly, it is possible to avoid the application of the transfer assist layer 94 over the toner layer 92 on the photoreceptor 90 (as in FIG. 7a), and to instead apply the transfer assist layer 94 with a metering roller (not shown) directly to the intermediate transfer member 14 before the toned image film 92 is transferred thereon. This could be embodied in the apparatus of FIG. 5 by the addition of a cartridge or applicator (not shown) in contact with the intermediate transfer member 14 and between the intermediate transfer member 14 and the final receptor 8 in a position to contact the intermediate transfer member 14 prior to the point where the photoreceptor 90 contacts the intermediate transfer member 14. In this embodiment, a charge director is not required. Additionally, this embodiment takes advantage of the transfer assist layer 94 on the surface of the image 92 on the final receptor 98 to promote such features as ultraviolet protection and abrasion resistance, for example.

These embodiments above describe basic arrangements of using a transfer assist layer in a multi-pass electrophotographic process that uses adhesive transfer. In accordance with the present invention, the transfer assist layer can be applied between any toner layers, if desired. Further, it is possible for multiple transfer assist layers to be applied in a particular electrophotographic process, such as may be done so that various transfer assist layers may provide different advantageous properties to the image and processes.

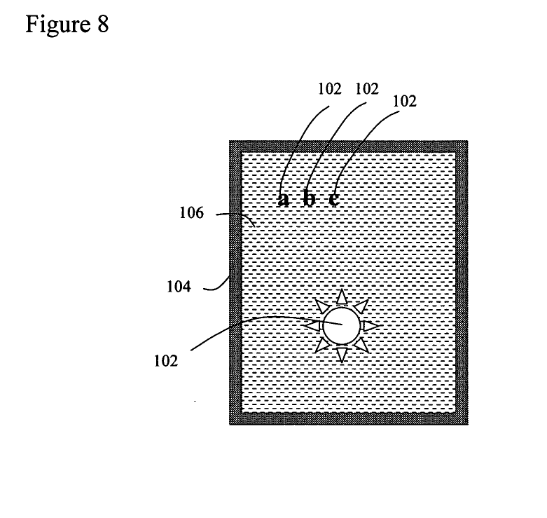

The various figures for this invention illustrate a transfer assist layer that covers the same approximate area as the toner film area or toner layers (known as “imagewise” application). This is for representative purposes only, where actual applications may include toner layers and transfer assist layers of various thicknesses and coverage areas, even within a single imaging process. For example, FIG. 8 illustrates a photoreceptor 104 plated or generally covered with a transfer assist layer 106 that will contact the final receptor (not shown). This transfer assist layer may be applied as a “flood coating”, for example, where the entire drum or photoreceptor is coated with the transfer assist material before the application of any toner images. This might be particularly useful if the transfer assist layer 106 is to end up on the surface of the printed image, such as to serve as a protective coating. The toner may then be applied in an imagewise manner on top of the transfer assist layer 106 in toner image areas 102, and then both the image areas 102 and transfer assist layer 106 may be transferred to a final image receptor.

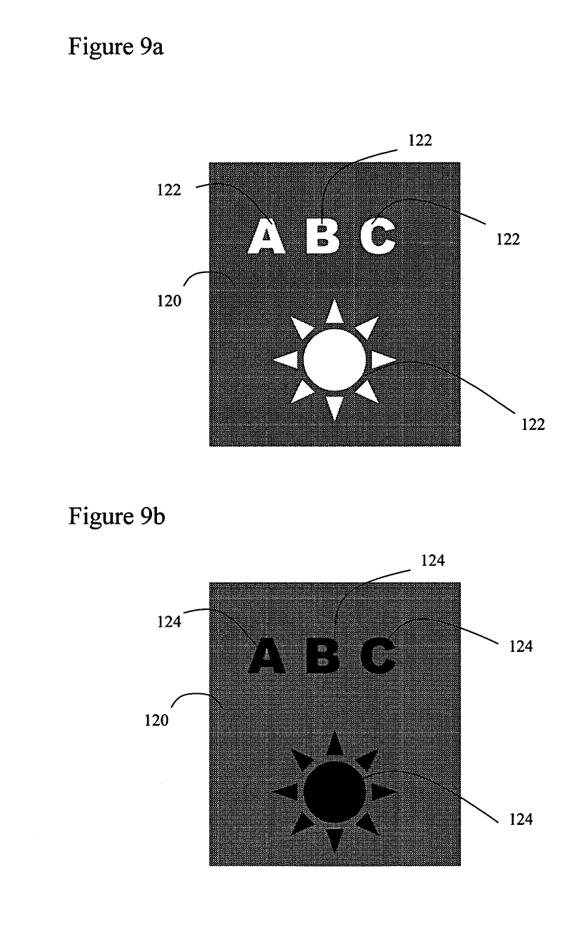

In a preferred embodiment, as seen in FIG. 9a, the transfer assist material may be only applied to a photoreceptor 120 in image areas 122 where an image will be applied, such that the areas surrounding these image areas 122 will be void of any applied transfer assist material (“imagewise”). Toner images 124 may then be applied to these image areas 122, as shown in FIG. 9b. This type of system might be most desired where the primary purpose of the transfer assist layer or material is to provide a release from the photoreceptor or the intermediate transfer member.

The operation of the present invention will be further described with regard to the following detailed examples. These examples are offered to further illustrate the various specific and preferred embodiments and techniques. It should be understood, however, that many variations and modifications might be made while remaining within the scope of the present invention.

### EXAMPLES

Test Methods and Apparatus for Transfer Assist Material and Liquid Toner Preparation

Percent Solids

In the following toner composition examples, percent solids of the graft stabilizer solutions, the organosol, and the liquid toner dispersions were determined thermo-gravimetrically by drying in an aluminum weighing pan an originally-weighed sample at 160° C. for two hours for graft stabilizer and organosol and for three hours for liquid toner, weighing the dried sample, and calculating the percentage ratio of the dried sample weight to the original sample weight, after accounting for the weight of the aluminum weighing pan. Approximately two grams of sample were used in each determination of percent solids using this thermo-gravimetric method.

Molecular Weight

In the practice of the invention, molecular weight is normally expressed in terms of the weight average molecular weight, while molecular weight polydispersity is given by the ratio of the weight average molecular weight to the number average molecular weight. Molecular weight parameters were determined with gel permeation chromatography (GPC method) using tetrahydrofuran as the carrier solvent. Absolute weight average molecular weights were determined using a Dawn DSP-F light scattering detector (Wyatt Technology Corp., Santa Barbara, Calif.), while polydispersity was evaluated by ratioing the measured weight average molecular weight to a measured value of number average molecular weight determined with an Optilab 903 differential refractometer detector (Wyatt Technology Corp., Santa Barbara, Calif.) calibrated to polystyrene homopolymer calibration standards.

Glass Transition Temperature

Thermal transition data for synthesized toner materials was collected using a TA Instruments Model 2929 Differential Scanning Calorimeter (New Castle, Del.) equipped with a DSC refrigerated cooling system (−70° C. minimum temperature limit), and dry helium and nitrogen exchange gases. The calorimeter ran on a Thermal Analyst 2100 workstation with version 8.10B software. An empty aluminum pan was used as the reference. The samples were prepared by placing 6.0 to 12.0 mg of the experimental material into an aluminum sample pan and crimping the upper lid to produce a hermetically sealed sample for DSC testing. The results were normalized to a unit mass basis. Each sample was evaluated using 10° C./min heating and cooling rates with a 5-10 min isothermal hold at the end of each heating or cooling ramp. The experimental materials were cycled through a heating and cooling ramp five times: the first heating ramp removes the previous thermal history of the sample and replaces it with the 11° C./min cooling treatment and subsequent heat ramps are used to obtain a stable glass transition temperature value; values are reported from either the third or fourth heat ramp.

Particle Size

Organosol and toner particle size distributions were determined by the Laser Diffraction Light Scattering Method using a Horiba LA-920 laser diffraction particle size analyzer (Horiba Instruments, Inc., Irvine, Calif.). Samples are diluted approximately 1/500 by volume and sonicated for one minute at 150 watts and 20 kHz prior to measurement. Particle size was expressed as both a number mean diameter (Dₙ) and a volume mean diameter (Dᵥ) and in order to provide an indication of both the fundamental (primary) particle size and the presence of aggregates or agglomerates.

Conductivity

The liquid toner conductivity (bulk conductivity, kb) was determined at approximately 18 Hz using a Scientifica Model 627 conductivity meter (Scientifica Instruments, Inc., Princeton, N.J.). In addition, the free (liquid dispersant) phase conductivity (k_{f}) in the absence of toner particles was also determined. Toner particles were removed from the liquid medium by centrifugation at 5° C. for 1-2 hours at 6,000 rpm (6,110 relative centrifugal force) in a Jouan MR1822 centrifuge (Winchester, Va.). The supernatant liquid was then carefully decanted, and the conductivity of this liquid was measured using a Scientifica Model 627 conductance meter. The percentage of free phase conductivity relative to the bulk toner conductivity was then determined as 100% (k_{f}/k_{b}).

Mobility

Toner particle electrophoretic mobility (dynamic mobility) was measured using a Matec MBS-8000 Electrokinetic Sonic Amplitude Analyzer (Matec Applied Sciences, Inc., Hopkinton, Mass.). Unlike electrokinetic measurements based upon microelectrophoresis, the MBS-8000 instrument has the advantage of requiring no dilution of the toner sample in order to obtain the mobility value. Thus, it was possible to measure toner particle dynamic mobility at solids concentrations actually preferred in printing. The MBS-8000 measures the response of charged particles to high frequency (1.2 MHz) alternating (AC) electric fields. In a high frequency AC electric field, the relative motion between charged toner particles and the surrounding dispersion medium (including counter-ions) generates an ultrasonic wave at the same frequency of the applied electric field. The amplitude of this ultrasonic wave at 1.2 MHz can be measured using a piezoelectric quartz transducer; this electrokinetic sonic amplitude (ESA) is directly proportional to the low field AC electrophoretic mobility of the particles. The particle zeta potential can then be computed by the instrument from the measured dynamic mobility and the known toner particle size, liquid dispersant viscosity, and liquid dielectric constant.

Q/M

The charge per mass measurement (Q/M) was measured using an apparatus that consists of a conductive metal plate, a glass plate coated with Indium Tin Oxide (ITO), a high voltage power supply, an electrometer, and a personal computer (PC) for data acquisition. A 1% solution of ink was placed between the conductive plate and the ITO coated glass plate. An electrical potential of known polarity and magnitude was applied between the ITO coated glass plate and the metal plate, generating a current flow between the plates and through wires connected to the high voltage power supply. The electrical current was measured 100 times a second for 20 seconds and recorded using the PC. The applied potential causes the charged toner particles to migrate towards the plate (electrode) having opposite polarity to that of the charged toner particles. By controlling the polarity of the voltage applied to the ITO coated glass plate, the toner particles may be made to migrate to that plate.

The ITO coated glass plate was removed from the apparatus and placed in an oven for approximately 30 minutes at 55° C. to dry the plated ink completely. After drying, the ITO coated glass plate containing the dried ink film was weighed. The ink was then removed from the ITO coated glass plate using a cloth wipe impregnated with Norpar™ 12, and the clean ITO glass plate was weighed again. The difference in mass between the dry ink coated glass plate and the clean glass plate is taken as the mass of ink particles (m) deposited during the 20 second plating time. The electrical current values were used to obtain the total charge carried by the toner particles (O) over the 20 seconds of plating time by integrating the area under a plot of current vs. time using a curve-fitting program (e.g. TableCurve 2D from Systat Software Inc.). The charge per mass (Q/m) was then determined by dividing the total charge carried by the toner particles by the dry plated ink mass.

Materials

The following abbreviations are used in the examples:
AIBN: Azobisisobutyronitrile (a free radical initiator available as VAZO-64 from DuPont Chemical Co., Wilmington, Del.)
DBTDL: Dibutyl tin dilaurate (a catalyst available from Aldrich Chemical Co., Milwaukee, Wis.)
EA: Ethyl acrylate (available from Aldrich Chemical Co., Milwaukee, Wis.)
EHMA: 2-Ethylhexyl methacrylate (available from Aldrich Chemical Co., Milwaukee, Wis.)
EMA: Ethyl methacrylate (available from Aldrich Chemical Co., Milwaukee, Wis.)
HEMA: 2-Hydroxyethyl methacrylate (available from Aldrich Chemical Co., Milwaukee, Wis.)
MAA: Methacrylate acid (available from Aldrich Chemical Co., Milwaukee, Wis.)
MMA: Methyl methacrylic acid (Aldrich Chemical Co., Milwaukee, Wis.)
PDMSMA: Polydimethyl siloxane mono-methacrylate (available from Aldrich Chemical Co., Milwaukee, Wis.)
TCHMA: Trimethyl cyclohexyl methacrylate (available from Ciba Specialty Chemical Co., Suffolk, Va.)
TMI: Dimethyl-m-isopropenyl benzyl isocyanate (available from CYTEC Industries, West Paterson, N.J.)
TMSEMA: 2-(trimethylsilyoxy) ethyl methacrylate (available from Aldrich Chemical Co., Milwaukee, Wis.)
V-601: Dimethyl 2,2′-azobisisobutyrate (a free radical initiator available as V-601 from WAKO Chemicals U.S.A., Richmond, Va.)
Zirconium HEX-CEM: (metal soap, zirconium tetraoctoate, available from OMG Chemical Company, Cleveland, Ohio)
   Nomenclature

In the following examples, the compositional details of each copolymer will be summarized by ratioing the weight percentages of monomers used to create the copolymer. The grafting site composition is expressed as a weight percentage of the monomers comprising the copolymer or copolymer precursor, as the case may be. For example, a graft stabilizer designated TCHMA/HEMA-TMI (97/3-4.7) is made by copolymerizing, on a relative basis, 97 parts by weight TCHMA and 3 parts by weight HEMA, and this hydroxy functional polymer is then reacted with 4.7 parts by weight of TMI via formation of a urethane linkage with the isocyanate, leaving a pendant vinyl group as a grafting site.

Similarly, a graft copolymer organosol designated TCHMA/HEMA-TMI//EMA (97-3-4.7/100) is made by copolymerizing the designated graft stabilizer (TCHMA/HEMA-TMI (97/3-4.7)) (S portion or shell) with the designated core monomer EMA (D portion or core, 100% EMA) at a specified ratio of D/S (core/shell) determined by the relative weights reported in the examples.

Preparation of Graft Stabilizer for Transfer Assist Materials

TABLE 1
Graft Stabilizers

| Composition | Graft Stabilizer Compositions | Solids | Molecular Weight | |
|---|---|---|---|---|
| Number | (% w/w) | (%) | M_{w} | M_{w}/Mₙ |
| 1 | EHMA/HEMA-TMI | 26.0 | 201,500 | 3.3 |
| | (97/3-4.7) | | | |
| 2 | TCHMA/HEMA-TMI | 26.2 | 251,300 | 2.8 |
| | (97/3-4.7) | | | |

Composition 1 (Comparative)

A 5000 ml 3-neck round flask equipped with a condenser, a thermocouple connected to a digital temperature controller, a nitrogen inlet tube connected to a source of dry nitrogen and an overhead stirrer, was charged with a mixture of 2561 g of Norpar™ 12, 849 g of EHMA, 26.7 g of 98% HEMA and 8.31 g of AIBN. While stirring the mixture, the reaction flask was purged with dry nitrogen for 30 minutes at flow rate of approximately 2 liters/minute. A hollow glass stopper was then inserted into the open end of the condenser and the nitrogen flow rate was reduced to approximately 0.5 liters/min. The mixture was heated to 70° C. for 16 hours. The conversion was quantitative.

The mixture was heated to 90° C. and held at that temperature for 1 hour to destroy any residual AIBN, and then was cooled back to 70° C. The nitrogen inlet tube was then removed, and 13.6 g of 95% DBTDL were added to the mixture, followed by 41.1 g of TMI. The TMI was added drop wise over the course of approximately 5 minutes while stirring the reaction mixture. The nitrogen inlet tube was replaced, the hollow glass stopper in the condenser was removed, and the reaction flask was purged with dry nitrogen for 30 minutes at a flow rate of approximately 2 liters/minute. The hollow glass stopper was reinserted into the open end of the condenser and the nitrogen flow rate was reduced to approximately 0.5 liters/min. The mixture was allowed to react at 70° C. for 6 hours, at which time the conversion was quantitative.

The mixture was then cooled to room temperature. The cooled mixture was a viscous, transparent liquid containing no visible insoluble mater. The percent solids of the liquid mixture was determined to be 26.0% using the thermo-gravimetric method described above. Subsequent determination of molecular weight was made using the GPC method described above; the copolymer had a M_{w} of 201,500 Da and M_{w}/Mₙ of 3.3 based on two independent measurements. The product is a copolymer of EHMA and HEMA with a TMI grafting site and is designated herein as EHMA/HEMA-TMI (97/3-4.7% w/w) and is suitable for making an organosol.

Composition 2

A 50 gallon reactor equipped with a condenser, a thermocouple connected to a digital temperature controller, a nitrogen inlet tube connected to a source of dry nitrogen and a mixer, was charged with a mixture of 201.9 lb of Norpar™ 12, 66.4 lb of TCHMA, 2.10 lb of 98% HEMA and 0.86 lb of Wako V-601. While stirring the mixture, the reactor was purged with dry nitrogen for 30 minutes at flow rate of approximately 2 liters/minute, and the nitrogen flow rate was reduced to approximately 0.5 liters/min. The mixture was heated to 75° C. for 4 hours. The conversion was quantitative.

The mixture was heated to 100° C. and held at that temperature for 1 hour to destroy any residual V-601, and then was cooled back to 70° C. The nitrogen inlet tube was then removed, and 0.11 lb of 95% DBTDL was added to the mixture, followed by 3.23 lb of TMI. The TMI was added drop wise over the course of approximately 5 minutes while stirring the reaction mixture. The mixture was allowed to react at 70° C. for 2 hours, at which time the conversion was quantitative.

The mixture was then cooled to room temperature. The cooled mixture was a viscous, transparent liquid containing no visible insoluble mater. The percent solids of the liquid mixture was determined to be 26.2% using the thermo-gravimetric method described above. Subsequent determination of molecular weight was made using the GPC method described above; the copolymer had a M_{w} of 251,300 and M_{w}/Mₙ of 2.8 based on two independent measurements. The product is a copolymer of TCHMA and HEMA with a TMI grafting site and is designated herein as TC A/EMA-TMI (97/3-4.7% w/w) and can be used to make an organosol.

Preparation of Organosol for Transfer Assist Materials

TABLE 2
Organosol Compositions

| | | | SILICONE |
|---|---|---|---|
| Composition | | Core/ | FUNCTIONAL |
| Numbers | Organosol Compositions (% w/w) | Shell | MONOMER |
| 3 | EHMA/HEMA-TMI//EA/MMA | 8 | None |
| | (97/3-4.7//75/25) | | |
| 4 | TCHMA/HEMA- | 7.0 | TMSEMA |
| | TMI//EA/MMA/TMSEMA | | |
| | (97/3-4.7//67.5/22.5/10) | | |
| 5 | PDMSMA//EA/MMA | 4 | PDMSMA |
| | (100//75/25) | | |

Composition 3 (Comparative)

This is an example using the graft stabilizer from Composition 1 to prepare an organosol without any silicone functional monomers. A 5000 ml 3-neck round flask equipped with a condenser, a thermocouple connected to a digital temperature controller, a nitrogen inlet tube connected to a source of dry nitrogen and an overhead stirrer, was charged with a mixture of 2568 g of Norpar™ 12, 468.05 g of EA, 154.17 g of MMA, 299.15 g of the graft stabilizer mixture from Example 1 @ 26.0% polymer solids, and 10.50 g of V-601 were combined. The mixture was heated to 70° C. for 16 hours. The conversion was quantitative. The mixture then was cooled to room temperature. Approximately 500 g of n-heptane were added to the cooled organosol, and the resulting mixture was stripped of residual monomer using a rotary evaporator equipped with a dry ice/acetone condenser and operating at a temperature of 90° C. and a vacuum of approximately 15 mm Hg. The stripped organosol was cooled to room temperature, yielding an opaque white dispersion. This organosol is designated EHMA/HEMA-TMI//EA/MMA (97/3-4.71175/25% w/w).

The percent solids of the organosol dispersion after stripping was determined as 21.8% using the thermo-gravinetric method described above. Subsequent determination of average particles size was made using the light scattering method described above; the organosol had a volume average diameter of 18.1 microns. The organosol particles had a T_{g} of 6.6° C. measured using the DSC method described above.

Composition 4

This is an example using the graft stabilizer in Composition 2 to prepare an organosol containing silicone functional monomers. Using the method and apparatus of Composition 3, 2633 g of Norpar™ 12, 421.24 g of EA, 138.76 g of MMA, 56.00 g of TMSEMA (silicone functional monomer), 296.86 g of the graft stabilizer mixture from Composition 2 @ 26.2% polymer solids, and 10.50 g of V-601 were combined. The mixture was heated to 70° C. for 16 hours. The conversion was quantitative. The mixture then was cooled to room temperature. After stripping the organosol using the method of Comparative Example 3 to remove residual monomer, the stripped organosol was cooled to room temperature, yielding an opaque white dispersion. This organosol is designated TCHMA/HEMA-TMI//EA/MMA/TMSEMA (97/3-4.71167.5122.5/10% w/w).

The percent solids of the organosol dispersion after stripping was determined as 18.50% using the thermo-gravimetric method described above. Subsequent determination of average particles size was made using the light scattering method described above; the organosol had a volume average diameter of 37.1 microns. The organosol particles had a T_{g} of 6.7° C. measured using the DSC method described above.

Composition 5

This is an example using the silicone functional macromer PDMSMA as a graft stabilizer to prepare an organosol containing silicone functional monomers. A 5000 ml, 3-necked round bottom flask equipped with a condenser, a thermocouple connected to a digital temperature controller, a nitrogen inlet tube connected to a source of dry nitrogen and an overhead stirrer, was charged with a mixture of 3074 g of Norpar™ 12, 84 g of PDMSMA, 84 g of MMA, 252 g of EA, and 6.3 g of AIBN. While the mixture was stirred, the reaction flask was purged with dry nitrogen for 30 minutes at a flow rate of approximately 2 liters/minute. A hollow glass stopper was then inserted into the open end of the condenser and the nitrogen flow rate was reduced to approximately 0.5 liter/min. The mixture was heated to 70° C. with stirring, and the mixture was allowed to polymerize at 70° C. for 16 hours. The conversion was quantitative.

Approximately 350 g of n-heptane were added to the cooled organosol, and the resulting mixture was stripped of residual monomer using a rotary evaporator equipped with a dry ice/acetone condenser and operating at a temperature of 90° C. and a vacuum of approximately 15 mm Hg. The stripped organosol was cooled to room temperature, yielding an opaque white dispersion. This organosol is designated PDMSMA//EA/MMA (100//75/25).

The percent solids of this organosol dispersion was determined to be 14.7% after stripping, using the thermogravimetric method described above. Subsequent determination of average particle size was made using the light scattering method described above; the organosol had a volume average particle size of 0.21 micron.

Preparation of Charged Transfer Assist Materials

Comparative Composition 6

The organosol prepared in Composition 3 was used to make a charged transfer assist material without silicone functional monomers as follows: 103.21 g of the organosol in Composition 3 @ 21.8% (w/w) solids in Norpar™ 12 were combined with 646.79 g of Norpar™ 12, and 7.94 g of 5.67% Zirconium HEX-CEM solution (OMG Chemical Company, Cleveland, Ohio). This mixture was mixed on a mechanical shaker table for 24 hours.

A 3% (w/w) solids dispersion of charged transfer assist material exhibited the following properties as determined using the test methods described above:
Volume Mean Particle Size: 31.6 microns Q/M: 95 μC/g
Bulk Conductivity: 10.1 picoMhos/cm
Percent Free Phase Conductivity: 33.46%
Dynamic Mobility: 1.13 E-11 (m²/Vsec)
   Composition 7

The organosol prepared in Composition 4 was used to make a charged transfer assist material containing silicone functional monomers as follows: 227 g of the organosol prepared in Composition 4 @ 18.50% (w/w) solids in Norpar 12 were combined with 58 g of Norpar 12, and 14.81 g of 5.67% Zirconium HEX-CEM solution (OMG Chemical Company, Cleveland, Ohio) in an 8 ounce glass jar. This mixture was then milled in a 0.5 liter vertical bead mill (Model 6TSG-1/4, Amex Co., Ltd., Tokyo, Japan) charged with 390 g of 1.3 mm diameter Potters glass beads (Potter Industries, Inc., Parsippany, N.J.). The mill was operated at 2,000 RPM for 1.5 hours without cooling water circulating through the cooling jacket of the milling chamber.

A 3% (w/w) solids dispersion of the charged transfer assist material exhibited the following properties as determined using the test methods described above:
Volume Mean Particle Size: 1.04 microns
Q/M: 367 C/g
Bulk Conductivity: 237 picoMhos/cm
Percent Free Phase Conductivity: 8.52%
Dynamic Mobility: 1.08E-11 (m²/Vsec)
   Composition 8

The organosol prepared in Composition 5 was used to make a charged transfer assists material containing a silicone functional monomer as follows: 1400 g of the organosol prepared in Composition 5 @ 14.7% (w/w) in Norpar 12 were combined with 2.28 g of 5.67% Zirconium HEX-CEM solution (OMG Chemical Company, Cleveland, Ohio). This mixture was put on a shaker table for 10 minutes.

A 3% (w/w) solids dispersion of charged transfer assist material exhibited the following properties as determined using the test methods above:
Volume Mean Particle Size: 0.21 micron
Q/M: 293 C/g
Bulk Conductivity: 351 picoMhos/cm
Percent Free Phase Conductivity: 15.75%
Dynamic Mobility: 1.74E-12 (m²/Vsec)
   Preparation of Liquid Toner
   Composition 9

This is an example of preparing a black liquid toner at an organosol pigment ratio of 6 using the organosol prepared in Composition 3.142 g of the organosol @ 21.8% (w/w) solids in Norpar™ 12 were combined with 151 g of Norpar™ 12, 5 g of Black pigment (Aztech EK8200, Mcgruder Color Company, Tucson, Ariz.) and 1.81 g of 5.67% Zirconium HEX-CEM solution (OMG Chemical Company, Cleveland, Ohio) in an 8 ounce glass jar. This mixture was then milled in a 0.5 liter vertical bead mill (Model 6TSG-1/4, Amex Co., Ltd., Tokyo, Japan) charged with 390 g of 1.3 mm diameter Potters glass beads (Potter Industries, Inc., Parsippany, N.J.). The mill was operated at 2,000 RPM for 1.5 hours without cooling water circulating through the cooling jacket of the milling chamber.

A 12% (w/w) solids toner concentrate exhibited the following properties as determined using the test methods described above:
Volume Mean Particle Size: 1.18 microns
Q/M: 397 μC/g
Bulk Conductivity: 1297 picoMhos/cm
Percent Free Phase Conductivity: 2.47%
Dynamic Mobility: 1.17E-10 (m²/Vsec)
   Print Testing with Transfer Assist Materials

The prints generated for the Examples were made on a prototype liquid electrophotographic printer configuration similar to the apparatus shown and described in FIG. 5. In the Examples, two development stations (two of 4a, 4b, 4c, 4d, and 4e) were filled with either liquid toner comprising charged toner particles or the liquid transfer assist material comprising charged particles, depending on the example.

In multipass printing, the main image formation element (which may be a central photoreceptor or a central intermediate transfer member) undergoes multiple revolutions for each complete toned image. The number of revolutions or passes corresponds to the number of development stations used for the toned image to be created. In the printing apparatus used for the Examples, the photoreceptive element 2 was the main image formation element and was charged to between 750V and 1000V for each revolution, then discharged in an imagewise manner to create a latent image on the surface of the photoreceptive element 2 with laser radiation from a scanner driven in response to image data sent from a computerized controller. The charging and discharging apparatus are not shown. For each print, a bitmap simulating a portion of a newspaper page consisting of pictoral images, graphs, and various fonts and sizes of text was used.

Two photoreceptive elements were used and will be designated as photoreceptor A and B in the Examples as described herein. Photoreceptor A was an inverted-dual layer photoreceptive web (such as the one described in U.S. Pat. No. 5,518,853) affixed to a drum, wherein the surface had a relatively high surface energy. Photoreceptor B was also an inverted dual layer photoreceptive web having a low surface energy release coating over the surface (an example of such a release coating is found in U.S. Application No. 5,733,698).

During a first revolution or pass, for each Example, the operator chose to position either the development station containing the charged liquid toner or the development station containing the charged transfer assist material to electrostatically transfer the charged particles onto the chosen photoreceptive element 2. The material to be applied first was attracted to the discharged regions or latent image area of the photoreceptive element 2. The photoreceptive element 2 bearing the transferred charged particles from the chosen first development station was then rotated one full revolution of the photoreceptive element 2 while the development station containing the material to be applied second was moved into a position adjacent to the photoreceptive element 2. The photoreceptive element 2 was again charged and laser discharged (as mentioned for the first pass, above) and the charged particles of the second material to be applied to the photoreceptive element 2 were electrostatically transferred onto the photoreceptive element 2 over at least a portion of the previous applied material in a second pass of the photoreceptive element 2.

Once the liquid toner and the liquid transfer assist material formed a complete toned image on the photoreceptive element 2, a heated drying roller 15, having an absorbent coating, was passed over the image on the photoreceptive element 2 with ten to twenty-five pounds of force (sufficient force to make intimate contact with the toned image on the photoreceptive element 2 without squashing or distorting it) and a temperature of about 60° C. The heated drying roller 15 removed substantially all the liquid carrier by absorption and evaporation, causing the toned image on the photoreceptive element 2 to become substantially dry (around 75% dry as determined by the thermogravimetric method described previously) and form a cohesive film.

The substantially dry and film-formed toned image on the photoreceptive element 2 was rotated to a position just prior to a heated intermediate transfer member 14 (about 85° C.), which was engaged to contact the photoreceptive element 2 with a force sufficient to cause intimate contact between the heated intermediate transfer member 14 and the complete toned image without distortion (about sixty to seventy pounds of force). The heated intermediate transfer member 14 had a higher surface energy than that of the photoreceptive element 2, and the toned image film was transferred from the photoreceptive element 2, to the intermediate transfer member 14.

The complete toned image on the intermediate transfer member 14 was then rotated to a position where it was brought into contact with a final image receptor 8, in these Examples, paper. The paper 8, having a higher surface energy than the intermediate transfer member 14, was pressed by a heated back up roller 10 (about 105° C. and about sixty to seventy pounds of force) to the image film on the heated intermediate transfer member 14. The image film adhered to the high surface energy surface of the paper 8 and was affixed there via the heat from the intermediate transfer member 14 and the heated backup roller 10.

### EXAMPLE 1 (COMPARATIVE)

This is an example of a charged organosol that is not suitable for use as a transfer assist material. Using the printing method and apparatus as described above, the charged organosol described as Composition 6 was placed in one development station and the liquid ink described as Composition 9 was placed in the other development station. The results of the testing are shown in Table 3, below.

The photoreceptive element A (without a release layer) was positioned for use. A control sample was run, wherein the liquid ink was developed on the latent image on the photoreceptive element, dried with the heated drying roller, then transferred to the intermediate transfer member and, finally printed to the final image receptor (paper) as described in the print method. The high surface energy of the photoreceptive element caused the liquid ink to remain on the photoreceptor and did not permit the transfer of the liquid ink particles to transfer off of the photoreceptive element in subsequent steps.

In a first experiment, the charged organosol was developed on the latent image on the photoreceptive element in one pass, then the liquid ink was developed on the photoreceptive element over the charged organosol in a subsequent pass, dried with the heated drying roller, then transferred to the intermediate transfer member and, finally printed to the final image receptor (paper) as described in the print method. The high surface energy of the photoreceptive element caused the layer comprising charged organosol and liquid ink to remain on the photoreceptor and did not permit the transfer of the substantially dried particles from the photoreceptive element in subsequent steps.

In a second experiment, the liquid ink was developed on the latent image on the photoreceptive element in one pass, then the charged organosol was developed on the photoreceptive element over the liquid ink in a subsequent pass, dried with the heated drying roller, then transferred to the intermediate transfer member and, finally printed to the final image receptor (paper) as described in the print method. The high surface energy of the photoreceptive element caused the layer comprising the liquid ink and charged organosol to remain on the photoreceptor and did not permit the transfer of the substantially dried particles from the photoreceptive element in subsequent steps.

In a third experiment, the Photoreceptor A was removed and replaced with Photoreceptor B. Again, the liquid ink was developed on the latent image on the photoreceptive element, dried with the heated drying roller, then transferred to the intermediate transfer member and, finally printed to the final image receptor (paper) as described in the print method in a control step. The low surface energy of the release layer permitted the ink layer to transfer off of the photoreceptor, to the intermediate transfer member, and finally to paper.

In a fourth experiment, photoreceptor B was also used. The imaging process was again activated and the charged organosol was developed on the latent image on the photoreceptive element in one pass. The liquid ink was developed on the photoreceptive element over the transfer assist material in a subsequent pass, dried with the heated drying roller, then transferred to the intermediate transfer member and, finally printed to the final image receptor (paper) as described in the print method. The image layer comprising the charged organosol and liquid ink were successfully transferred to paper.

In a fifth experiment, photoreceptor B was also used. The image process was again activated and the liquid ink was developed on the latent image on the photoreceptor in one pass. The charged organosol was developed on the photoreceptive element over the liquid ink in a subsequent pass, dried with the heated drying roller, then transferred to the intermediate transfer member and, finally printed to the final image receptor (paper) as described in the print method. The image layer comprising transfer assist material and liquid ink was successfully transferred to paper.

TABLE 3
COMPARATIVE EXAMPLE 1 results

| | | | | Transfer via |
|---|---|---|---|---|
| | | First layer on | Second Layer on | intermediate transfer |
| Sample ID | Photoreceptor | photoreceptor | photoreceptor | member to paper? |
| Control | A | Liquid ink | None | No |
| | | (Composition 9) | | |
| 1 | A | Composition 6 | Liquid ink | No |
| | | | (Composition 9) | |
| 2 | A | Liquid ink | Composition 6 | No |
| | | (Composition 9) | | |
| 3-Control | B | Liquid ink | None | Yes |
| | | (Composition 9) | | |
| 4 | B | Composition 6 | Liquid ink | Yes |
| | | | (Composition 9) | |
| 5 | B | Liquid ink | Composition 6 | Yes |
| | | (Composition 9) | | |

### EXAMPLE 2

This is an example of a charged organosol containing surface release materials that is suitable for use as a transfer assist material.

Using the printing method and apparatus as described above, the transfer assist material described as Composition 7 was placed in one development station and the liquid ink described as Composition 9 was placed in the other development station.

The photoreceptive element A (without a release layer) was positioned for use. A control sample was run, wherein the liquid ink was developed on the latent image on the photoreceptive element, dried with the heated drying roller, then transferred to the intermediate transfer member and, finally printed to the final image receptor (paper) as described in the print method. The high surface energy of the photoreceptive element caused the liquid ink to remain on the photoreceptor and did not permit the transfer of the liquid ink particles to transfer off of the photoreceptive element in subsequent steps.

In a first experiment, the transfer assist material was developed on the latent image on the photoreceptive element in one pass, then the liquid ink was developed on the photoreceptive element over the transfer assist material in a subsequent pass, dried with the heated drying roller, then transferred to the intermediate transfer member and, finally printed to the final image receptor (paper) as described in the print method. The transfer assist material functioned like a release layer, permitting transfer of the liquid ink to the intermediate transfer member and the paper.

In a second experiment, the liquid ink was developed on the latent image on the photoreceptive element in one pass, then the liquid transfer assist material was developed on the photoreceptive element over the liquid ink in a subsequent pass, dried with the heated drying roller, then transferred to the intermediate transfer member and, finally printed to the final image receptor (paper) as described in the print method. The high surface energy of the photoreceptive element caused the layer comprising the liquid ink and transfer assist material to remain on the photoreceptor and did not permit the transfer of the substantially dried particles from the photoreceptive element in subsequent steps.

In a third experiment, the Photoreceptor A was removed and replaced with Photoreceptor B. Again, the liquid ink was developed on the latent image on the photoreceptive element, dried with the heated drying roller, then transferred to the intermediate transfer member and, finally printed to the final image receptor (paper) as described in the print method in a control step. The low surface energy of the release layer permitted the ink layer to transfer off of the photoreceptor, to the intermediate transfer member, and finally to paper.

In a fourth experiment, photoreceptor B was also used. The imaging process was again activated and the transfer assist material was developed on the latent image on the photoreceptive element in one pass. The liquid ink was developed on the photoreceptive element over the transfer assist material in a subsequent pass, dried with the heated drying roller, then transferred to the intermediate transfer member and, finally printed to the final image receptor (paper) as described in the print method. The image layer comprising transfer assist material and liquid ink were successfully transferred to paper.

In a fifth experiment, photoreceptor B was also used. The image process was again activated and the liquid ink was developed on the latent image on the photoreceptor in one pass. The liquid transfer assist material was developed on the photoreceptive element over the liquid ink in a subsequent pass, dried with the heated drying roller, then transferred to the intermediate transfer member and, finally printed to the final image receptor (paper) as described in the print method. The image layer comprising transfer assist material and liquid ink were successfully transferred to paper.

TABLE 4
EXAMPLE 2 results

| | | | | Transfer via |
|---|---|---|---|---|
| | | First layer on | Second Layer on | intermediate transfer |
| Sample ID | Photoreceptor | photoreceptor | photoreceptor | member to paper? |
| Control | A | Liquid ink | None | No |
| | | (Composition 9) | | |
| 1 | A | Composition 7 | Liquid ink | Yes |
| | | | (Composition 9) | |
| 2 | A | Liquid ink | Composition 7 | No |
| | | (Composition 9) | | |
| 3-Control | B | Liquid ink | None | Yes |
| | | (Composition 9) | | |
| 4 | B | Composition 7 | Liquid ink | Yes |
| | | | (Composition 9) | |
| 5 | B | Liquid ink | Composition 7 | Yes |
| | | (Composition 9) | | |

### EXAMPLE 3

This is an example of a charged organosol containing surface release materials that is suitable for use as a transfer assist material.

Using the printing method and apparatus as described above, the transfer assist material described as Composition 8 was placed in one development station and the liquid ink described as Composition 9 was placed in the other development station.

The photoreceptive element A (without a release layer) was positioned for use. A control sample was run, wherein the liquid ink was developed on the latent image on the photoreceptive element, dried with the heated drying roller, then transferred to the intermediate transfer member and, finally printed to the final image receptor (paper) as described in the print method. The high surface energy of the photoreceptive element caused the liquid ink to remain on the photoreceptor and did not permit the transfer of the liquid ink particles to transfer off of the photoreceptive element in subsequent steps.

In a first experiment, the transfer assist material was developed on the latent image on the photoreceptive element in one pass, then the liquid ink was developed on the photoreceptive element over the transfer assist material in a subsequent pass, dried with the heated drying roller, then transferred to the intermediate transfer member and, finally printed to the final image receptor (paper) as described in the print method. The transfer assist material functioned like a release layer, permitting transfer of the liquid ink to the intermediate transfer member and the paper.

In a second experiment, the liquid ink was developed on the latent image on the photoreceptive element in one pass, then the liquid transfer assist material was developed on the photoreceptive element over the liquid ink in a subsequent pass, dried with the heated drying roller, then transferred to the intermediate transfer member and, finally printed to the final image receptor (paper) as described in the print method. The high surface energy of the photoreceptive element caused the layer comprising the liquid ink and transfer assist material to remain on the photoreceptor and did not permit the transfer of the substantially dried particles from the photoreceptive element in subsequent steps.

In a third experiment, the Photoreceptor A was removed and replaced with Photoreceptor B. Again, the liquid ink was developed on the latent image on the photoreceptive element, dried with the heated drying roller, then transferred to the intermediate transfer member and, finally printed to the final image receptor (paper) as described in the print method in a control step. The low surface energy of the release layer permitted the ink layer to transfer off of the photoreceptor, to the intermediate transfer member, and finally to paper.

In a fourth experiment, photoreceptor B was also used. The imaging process was again activated and the transfer assist material was developed on the latent image on the photoreceptive element in one pass. The liquid ink was developed on the photoreceptive element over the transfer assist material in a subsequent pass, dried with the heated drying roller, then transferred to the intermediate transfer member and, finally printed to the final image receptor (paper) as described in the print method. The image layer comprising transfer assist material and liquid ink were successfully transferred to paper.

In a fifth experiment, photoreceptor B was also used. The image process was again activated and the liquid ink was developed on the latent image on the photoreceptor in one pass. The liquid transfer assist material was developed on the photoreceptive element over the liquid ink in a subsequent pass, dried with the heated drying roller, then transferred to the intermediate transfer member and, finally printed to the final image receptor (paper) as described in the print method. The image layer comprising transfer assist material and liquid ink were successfully transferred to paper.

TABLE 5
EXAMPLE 3 results

| | | | | Transfer via |
|---|---|---|---|---|
| | | First layer on | Second Layer on | intermediate transfer |
| Sample ID | Photoreceptor | photoreceptor | photoreceptor | member to paper? |
| Control | A | Liquid ink | None | No |
| | | (Composition 9) | | |
| 1 | A | Composition 8 | Liquid ink | Yes |
| | | | (Composition 9) | |
| 2 | A | Liquid ink | Composition 8 | No |
| | | (Composition 9) | | |
| 3-Control | B | Liquid ink | None | Yes |
| | | (Composition 9) | | |
| 4 | B | Composition 8 | Liquid ink | Yes |
| | | | (Composition 9) | |
| 5 | B | Liquid ink | Composition 8 | Yes |
| | | (Composition 9) | | |

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. A method of producing a composite image on a final image receptor from image data in a multiple pass electrophotographic system, comprising the steps of:
providing a photoreceptive element having a determined processing cycle;
providing a transfer assist material development station containing a liquid transfer assist material comprising charged particles of transfer assist material dispersed in a first carrier liquid;
moving at least one of the photoreceptive element and the transfer assist material development station into a processing position relative to each other and applying the transfer assist material to at least a portion of the surface of the photoreceptive element during a processing cycle of the photoreceptive element;
providing at least one development station containing charged toner particles dispersed in a second carrier liquid, wherein at least one of the photoreceptive element and each development station are moved into a processing position relative to each other and performing the following steps (a) through (c) for each development station during each complete processing cycle of the photoreceptive element;
(a) applying a substantially uniform first electrostatic potential to the photoreceptive element;
(b) selectively discharging the photoreceptive element in an imagewise manner to create a first latent image having a second electrostatic potential that is less than the absolute value of the first electrostatic potential; and
(c) exposing the photoreceptive element to the charged toner particles, wherein the charged toner particles selectively deposit on the discharged portions of the surface of the photoreceptive element to develop the first latent image and create a toned image overlapping at least a portion of the transfer assist material on the surface of the photoreceptive element;
wherein the transfer assist material and the toned image on the photoreceptive element form a composite image layer;
substantially drying the composite image layer to remove at least a major portion of the second carrier liquid during the multiple processing cycles completed by the photoreceptive element;
contacting the composite image layer with a heated intermediate transfer member that provides a sufficient amount of heat and pressure to cause at least a portion of the substantially dried composite image layer to elastomerically transfer to the intermediate transfer member; and
contacting the composite image layer on the intermediate transfer member with a first side of a final image receptor having two sides and applying force to the second side of the final image receptor with a backup element causing the composite image layer to elastomerically transfer to the first side of the final image receptor.

2. The method of claim 1, further comprising the step of contacting the composite image layer on the photoreceptive element with a drying element prior to contacting the composite image layer with the intermediate transfer member.

3. The method of claim 2, wherein the drying element is heated.

4. The method of claim 2, wherein the drying element comprises a carrier liquid absorbent coating.

5. The method of claim 2, wherein the drying element is rotatable.

6. The method of claim 5, wherein the drying element is a belt.

7. The method of claim 1, wherein the substantially dried composite image layer comprises greater than 75% solids by weight.

8. The method of claim 1, wherein the force provided by the heated intermediate transfer member to transfer the composite image layer from the photoreceptive element to the intermediate transfer member is in the range of about 60 pounds to about 70 pounds of force.

9. The method of claim 1, wherein the force provided by the backup element to transfer the composite image layer from the intermediate transfer member to the final image receptor is in the range of about 60 pounds to about 70 pounds.

10. The method of claim 1, wherein the backup element is heated to at least 80° C.

11. The method of claim 10, wherein the backup element is heated to about 105° C.

12. The method of claim 1, wherein the steps (a) through (c) are repeated by at least two development stations, and wherein each sequence of the steps (a) through (c) is performed during a separate processing cycle of the photoreceptive element.

13. The method of claim 1, wherein the photoreceptive element is rotatable.

14. The method of claim 13, wherein the photoreceptive element is a photoreceptive drum.

15. The method of claim 1, wherein the surface of the photoreceptive element has an adhesive strength measured according to JIS Z 0237-1980 “Testing Methods of Pressure Sensitive Adhesive Tapes and Sheets” greater than 150 grams-force before the step of applying the transfer material.

16. The method of claim 1, wherein the toner particles have a glass transition temperature of less than about 35° C.

17. The method of claim 1, wherein the liquid transfer assist material is an organosol containing dispersed charged particles derived from a surface release promoting moiety.

18. The method of claim 1, wherein the transfer assist material comprises an additive to promote adhesion of the image layer to the final image receptor.

19. The method of claim 1, wherein the transfer assist material comprises an additive to enhance durability of the image layer on the final image receptor.

20. The method of claim 1, wherein the particles of the transfer assist material have a glass transition temperature between about −1° C. and about 35° C.

21. The method of claim 1, wherein the final image receptor is paper.

22. The method of claim 1, wherein the first and second carrier liquids comprise the same chemical material.

23. The method of claim 1, wherein the method of applying the transfer assist material to the photoreceptive element is electrophoretic development of the charged particles of transfer assist material in an imagewise manner corresponding to the sum of the image data used to produce each toned image.

24. The method of claim 1, wherein the step of selectively discharging the photoreceptive element comprises selectively exposing portions of the surface of the photoreceptive element to actinic radiation selected from the group consisting of ultraviolet radiation, visible light, and infrared radiation.

25. The method of claim 1, wherein the transfer assist material comprises an organosol having a glass transition temperature that is higher than the glass transition temperature of the liquid ink that comprises the toned image.

26. The method of claim 1, wherein the substantially dried composite image layer on the photoreceptive element forms a cohesive film.

27. A method of producing a composite image on a final image receptor from image data in a multiple pass electrophotographic system, comprising the steps of:
providing a photoreceptive element having a determined processing cycle;
providing a transfer assist material development station containing a liquid transfer assist material comprising charged particles of transfer assist material dispersed in a first carrier liquid;
moving at least one of the photoreceptive element and the transfer assist material development station into a processing position relative to each other and applying the transfer assist material to at least a portion of the surface of the photoreceptive element during a processing cycle of the photoreceptive element;
providing at least one development station containing charged toner particles dispersed in a second carrier liquid, wherein at least one of the photoreceptive element and each development station are moved into a processing position relative to each other and performing the following steps (a) through (c) for each development station during each complete processing cycle of the photoreceptive element;
(a) applying a substantially uniform first electrostatic potential to the photoreceptive element;
(b) selectively discharging portions of the photoreceptive element in an imagewise manner to create a first latent image having a second electrostatic potential that is less than the absolute value of the first electrostatic potential; and
(c) exposing the photoreceptive element to the charged toner particles, wherein the charged toner particles selectively deposit on the discharged portions of the photoreceptive element to develop the first latent image and create a toned image overlapping at least a portion of the transfer assist material on the surface of the photoreceptive element;
wherein the transfer assist material and the toned image on the photoreceptive element form a composite image layer;
substantially drying the composite image layer to remove at least a major portion of the second carrier liquid during the multiple processing cycles completed by the photoreceptive element; and
contacting the composite image layer with a first side of a final image receptor having two sides and applying force to the second side of the final image receptor with a backup element, causing the composite image layer to adhesively transfer to the first side of the final image receptor.

28. The method of claim 27, further comprising the step of contacting the composite image layer with a drying element while the composite image layer is still on the photoreceptive element.

29. The method of claim 28, wherein the drying element is heated.

30. The method of claim 28, wherein the drying element comprises a carrier liquid absorbent coating.

31. The method of claim 28, wherein the drying element is rotatable.

32. The method of claim 31, wherein the drying element is a belt.

33. The method of claim 27, wherein the substantially dried composite image layer comprises greater than 75% solids on a weight basis.

34. The method of claim 27, wherein the force provided by the backup element to transfer the composite image layer from photoreceptive element to the final image receptor is in the range of about 60 pounds to about 70 pounds of force.

35. The method of claim 27, wherein the backup element is heated to at least 80° C.

36. The method of claim 27, wherein the backup element is heated to about 105° C.

37. The method of claim 27, wherein the steps (a) through (c) are repeated by at least two development stations, and wherein each sequence of the steps (a) through (c) is performed during a separate processing cycle of the photoreceptive element.

38. The method of claim 27, wherein the photoreceptive element is rotatable.

39. The method of claim 38, wherein the photoreceptive element is a photoreceptive drum.

40. The method of claim 27, wherein the surface of the photoreceptive element has an adhesive strength measured according to JIS Z 0237-1980 “Testing Methods of Pressure Sensitive Adhesive Tapes and Sheets” greater than 150 grams-force before the step of applying the transfer material.

41. The method of claim 27, wherein the toner particles have a glass transition temperature of less than about 35° C.

42. The method of claim 27, wherein the transfer assist material is an organosol containing dispersed charged particles derived from a surface release promoting moiety.

43. The method of claim 27, wherein the particles of the transfer assist material have a volume mean particle size greater than 1 micron.

44. The method of claim 27, wherein the particles of the transfer assist material have surface release characteristics.

45. The method of claim 27, wherein the transfer assist material comprises an additive to enhance durability of the image layer on the final image receptor.

46. The method of claim 27, wherein the particles of the transfer assist material have a glass transition temperature between about −1° C. and about 35° C.

47. The method of claim 27, wherein the final image receptor is paper.

48. The method of claim 27, wherein the first and second carrier liquids comprise the same chemical material.

49. The method of claim 27, wherein the method of applying the transfer assist material to the photoreceptive element is electrophoretic development of the charged particles of transfer assist material in an imagewise manner corresponding to the sum of the image data used to produce each toned image.

50. The method of claim 27, wherein the step of selectively discharging portions of the photoreceptive element comprises selectively exposing portions of the surface of the photoreceptive element to actinic radiation selected from the group consisting of ultraviolet radiation, visible light, and infrared radiation.

51. The method of claim 27, wherein the transfer assist material comprises an organosol having a glass transition temperature that is higher than the glass transition temperature of the liquid ink that comprises the toned image.

52. The method of claim 27, wherein the substantially dried composite image layer on the photoreceptive element forms a cohesive film.

53. A method of producing a composite image on a final image receptor from image data in a multiple pass electrophotographic system, comprising the steps of:
providing a photoreceptive element having a determined processing cycle;
providing at least one development station containing charged toner particles dispersed in a first carrier liquid, wherein at least one of the photoreceptive element and each development station are moved into a processing position relative to each other and performing the following steps (a) through (c) for each development station during each complete processing cycle of the photoreceptive element;
(a) applying a substantially uniform first electrostatic potential to the photoreceptive element;
(b) selectively discharging portions of the photoreceptive element in an imagewise manner to create a first latent image having a second electrostatic potential that is less than the absolute value of the first electrostatic potential on the photoreceptive element; and
(c) exposing the photoreceptive element to the charged toner particles, wherein the charged toner particles selectively deposit on the discharged portions of the photoreceptive element to develop the first latent image and create a toned image on the surface of the photoreceptive element;
providing a transfer assist material development station containing a liquid transfer assist material comprising charged particles of transfer assist material dispersed in a second carrier liquid;
moving at least one of the photoreceptive element and the transfer assist material development station into a processing position relative to each other and applying the transfer assist material to overlap at least a portion of the toned image during the processing cycle of the photoreceptive element to form a composite image layer;
substantially drying the composite image layer to remove at least a major portion of the first carrier liquid on the photoreceptive element; and
contacting the composite image layer with a first side of a final image receptor having two sides and applying force to the second side of the final image receptor causing the composite image layer to adhesively transfer to the first side of the final image receptor.

54. The method of claim 53, further comprising the step of contacting the composite image layer on the photoreceptive element with a drying element while the composite image layer is still on the photoreceptive element.

55. The method of claim 54, wherein the drying element is heated.

56. The method of claim 54, wherein the drying element comprises a carrier liquid absorbent coating.

57. The method of claim 54, wherein the drying element is rotatable.

58. The method of claim 57, wherein the drying element is a belt.

59. The method of claim 53, wherein the substantially dried composite image layer comprises greater than 75% solids by weight.

60. The method of claim 53, wherein the force provided by the backup element to transfer the composite image layer from the photoreceptive element to the final image receptor is in the range of about 60 pounds of force to about 70 pounds of force.

61. The method of claim 53, wherein the backup element is heated to at least 80° C.

62. The method of claim 53, wherein the backup element is heated to about 105° C.

63. The method of claim 53, wherein the steps (a) through (c) are repeated by at least two development stations, and wherein each sequence of the steps (a) through (c) is performed during a separate processing cycle of the photoreceptive element.

64. The method of claim 53, wherein the photoreceptive element is rotatable.

65. The method of claim 64, wherein the photoreceptive element is a photoreceptive drum.

66. The method of claim 53, wherein the surface of the photoreceptive element has an adhesive strength measured according to JIS Z 0237-1980 “Testing Methods of Pressure Sensitive Adhesive Tapes and Sheets” greater than 150 grams-force before the step of applying the transfer material.

67. The method of claim 53, wherein the toner particles have a glass transition temperature of less than about 35° C.

68. The method of claim 53, wherein the transfer assist material is an organosol containing dispersed charged particles derived from a surface release promoting moiety.

69. The method of claim 53, wherein the transfer assist material comprises an additive to promote adhesion of the image layer to the final image receptor.

70. The method of claim 53, wherein the transfer assist material comprises an additive to enhance durability of the image layer on the final image receptor.

71. The method of claim 53, wherein the particles of the transfer assist material have a glass transition temperature between about −1° C. and 35° C.

72. The method of claim 53, wherein the particles of the transfer assist material have a volume mean particle size of at least 1 micron.

73. The method of claim 53, wherein the final image receptor is paper.

74. The method of claim 53, wherein the first and second carrier liquids comprise the same chemical material.

75. The method of claim 53, wherein the method of applying the transfer assist material to the photoreceptive element is electrophoretic development of the charged particles of transfer assist material in an imagewise manner corresponding to the sum of the image data used to produce each toned image.

76. The method of claim 53, wherein the step of selectively discharging portions of the photoreceptive element comprises selectively exposing portions of the surface of the photoreceptive element to actinic radiation selected from the group consisting of ultraviolet radiation, visible light, and infrared radiation.

77. The method of claim 53, wherein the transfer assist material comprises an organosol having a glass transition temperature that is higher than the glass transition temperature of the liquid ink that comprises the toned image.

78. The method of claim 53, wherein the substantially dried composite image layer on the photoreceptive element forms a cohesive film.

79. A method of producing a composite image on a final image receptor from image data in a multiple pass electrophotographic system, comprising the steps of:
providing a photoreceptive element having a determined processing cycle;
providing at least one development station containing charged toner particles dispersed in a first carrier liquid, wherein at least one of the photoreceptive element and each development station are moved into a processing position relative to each other and performing the following steps (a) through (c) for each development station during each complete processing cycle of the photoreceptive element;
(a) applying a substantially uniform first electrostatic potential to the photoreceptive element;
(b) selectively discharging portions of the photoreceptive element in an imagewise manner to create a first latent image having a second electrostatic potential that is less than the absolute value of the first electrostatic potential; and
(c) exposing the photoreceptive element to the charged toner particles, wherein the charged toner particles selectively deposit on the discharged portions of the photoreceptive element to develop the first latent image and create a toned image;
providing a transfer assist material development station containing a liquid transfer assist material comprising charged particles of transfer assist material dispersed in a second carrier liquid;
moving at least one of the photoreceptive element and the transfer assist material development station into a processing position relative to each other and applying the transfer assist material overlapping at least a portion of the toned image during the processing cycle of the photoreceptive element to form a composite image layer that is formed and substantially dried to remove carrier liquid on the photoreceptive element;
contacting the composite image layer with a heated intermediate transfer member that provides a sufficient amount of heat and force to cause the substantially dried composite image layer to elastomerically transfer to the intermediate transfer member; and
contacting the composite image layer with a first side of a final image receptor having two sides and applying force to the second side of the final image receptor with a backup element causing the composite image layer to elastomerically transfer to the first side of the final image receptor.

80. The method of claim 79, further comprising the step of contacting the composite image layer on the photoreceptive element with a drying element prior to contacting the composite image layer with the intermediate transfer member.

81. The method of claim 80, wherein the drying element is heated.

82. The method of claim 80, wherein the drying element comprises a carrier liquid absorbent coating.

83. The method of claim 80, wherein the drying element is rotatable.

84. The method of claim 83, wherein the drying element is a belt.

85. The method of claim 79, wherein the substantially dried composite image layer comprises greater than 75% solids by weight.

86. The method of claim 79, wherein the force provided by the heated intermediate transfer member to transfer the composite image layer from the photoreceptive element to the intermediate transfer member is in the range of about 60 pounds to about 70 pounds of force.

87. The method of claim 79, wherein the force provided by the backup element to transfer the composite image layer from the intermediate transfer member to the final image receptor is in the range of about 60 pounds to about 70 pounds of force.

88. The method of claim 79, wherein the backup element is heated to at least 80° C.

89. The method of claim 79, wherein the backup element is heated to about 105° C.

90. The method of claim 79, wherein the steps (a) through (c) are repeated by at least two development stations, and wherein each sequence of the steps (a) through (c) is performed during a separate processing cycle of the photoreceptive element.

91. The method of claim 79, wherein the photoreceptive element is rotatable.

92. The method of claim 91, wherein the photoreceptive element is a photoreceptive drum.

93. The method of claim 79, wherein the surface of the photoreceptive element has an adhesive strength measured according to JIS Z 0237-1980 “Testing Methods of Pressure Sensitive Adhesive Tapes and Sheets” greater than 150 grams-force before the step of applying the transfer material.

94. The method of claim 79, wherein the toner particles have a glass transition temperature of less than about 35° C.

95. The method of claim 79, wherein the transfer assist material is an organosol containing dispersed charged particles derived from a surface release promoting moiety.

96. The method of claim 79, wherein the particles of the transfer assist material have surface release characteristics.

97. The method of claim 79, wherein the transfer assist material comprises an additive to enhance durability of the image layer on the final image receptor.

98. The method of claim 79, wherein the particles of the transfer assist material have a glass transition temperature between about −1° C. and 35° C.

99. The method of claim 79, wherein the final image receptor is paper.

100. The method of claim 79, wherein the first and second carrier liquids comprise the same chemical material.

101. The method of claim 79, wherein the method of applying the transfer assist material over the toned image on the photoreceptive element is electrophoretic development of the charged particles of transfer assist material in an imagewise manner corresponding to the sum of the image data used to produce each toned image.

102. The method of claim 79, wherein the step of selectively discharging portions of the photoreceptive element comprises selectively exposing portions of the surface of the photoreceptive element to actinic radiation selected from the group consisting of ultraviolet radiation, visible light, and infrared radiation.

103. The method of claim 79, wherein the transfer assist material comprises an organosol having a glass transition temperature that is higher than the glass transition temperature of the liquid ink that comprises the toned image.

104. The method of claim 79, wherein the substantially dried composite image layer on the photoreceptive element forms a cohesive film.

105. A method of producing a composite image on a final image receptor from image data in a multiple pass electrophotographic system, comprising the steps of:
providing a photoreceptive element having a determined processing cycle;
providing at least one development station containing charged toner particles dispersed in a first carrier liquid, wherein at least one of the photoreceptive element and each development station are moved into a processing position relative to each other and performing the following steps (a) through (c) for each development station during each complete processing cycle of the photoreceptive element;
(a) applying a substantially uniform first electrostatic potential to the surface of the photoreceptive element;
(b) selectively discharging portions of the surface of the photoreceptive element in an imagewise manner to create a first latent image having a second electrostatic potential that is less than the absolute value of the first electrostatic potential on the surface of the photoreceptive element; and
(c) exposing the surface of the photoreceptive element to the charged toner particles, wherein the charged toner particles selectively deposit on the discharged portions of the surface of the photoreceptive element to develop the first latent image and create a toned image;
contacting the toned image with a heated intermediate transfer member that provides a sufficient amount of heat and force to cause the toned image to transfer to the intermediate transfer member;
providing a transfer assist material delivery station containing a liquid transfer assist material comprising particles dispersed in a second carrier liquid;
moving at least one of the intermediate transfer member and the transfer assist material delivery station into a processing position relative to each other and applying the transfer assist material to at least a portion of the toned image to form a composite image layer
substantially drying the composite image layer on the intermediate transfer member to remove at least a major portion of the second carrier liquid; and
contacting the composite image layer with a first side of a final image receptor having two sides and applying force to the second side of the final image receptor with a backup element causing the composite image layer to elastomerically transfer to the first side of the final image receptor.

106. The method of claim 105, further comprising the step of contacting the toned image layer on the photoreceptive element with a drying element prior to contacting the toned image layer with the intermediate transfer member.

107. The method of claim 106, wherein the drying element is heated.

108. The method of claim 106, wherein the drying element comprises an absorbent coating.

109. The method of claim 106, wherein the drying element is rotatable.

110. The method of claim 109, wherein the drying element is a belt.

111. The method of claim 105, wherein the substantially dried composite image layer comprises greater than 75% solids.

112. The method of claim 105, wherein the force provided by the heated intermediate transfer member to transfer the toned image from the photoreceptive element to the intermediate transfer member is in the range of about 60 pounds to about 70 pounds of force.

113. The method of claim 105, wherein the force provided by the backup element to transfer the composite image layer from the intermediate transfer member to the final image receptor is in the range of about 60 pounds of force to about 70 pounds of force.

114. The method of claim 105, wherein the backup element is heated to at least 80° C.

115. The method of claim 105, wherein the backup element is heated to about 105° C.

116. The method of claim 105, wherein the steps (a) through (c) are repeated by at least two development stations, and wherein each sequence of the steps (a) through (c) is performed during a separate processing cycle of the photoreceptive element.

117. The method of claim 105, wherein the photoreceptive element is rotatable.

118. The method of claim 117, wherein the photoreceptive element is a photoreceptive drum.

119. The method of claim 105, wherein the surface of the photoreceptive element has an adhesive strength measured according to JIS Z 0237-1980 “Testing Methods of Pressure Sensitive Adhesive Tapes and Sheets” greater than 150 grams-force before the step of applying the transfer material.

120. The method of claim 105, wherein the first and second carrier liquids comprise the same chemical material

121. The method of claim 105, wherein the toner particles have a glass transition temperature of less than about 35° C.

122. The method of claim 105, wherein the transfer assist material is a non-pigmented liquid toner comprising charged toner particles dispersed in a carrier liquid.

123. The method of claim 122, wherein the charged toner particles are applied to at least a portion of the toned image on the intermediate transfer member by an electrodeposition method.

124. The method of claim 105, wherein the transfer assist material comprises an additive to promote adhesion of the image layer to the final image receptor.

125. The method of claim 105, wherein the transfer assist material comprises an additive to enhance durability of the image layer on the final image receptor.

126. The method of claim 105, wherein the particles of the transfer assist material have a glass transition temperature between about −1° C. and about 35° C.

127. The method of claim 105, wherein the final image receptor is paper.

128. The method of claim 105, wherein the step of selectively discharging portions of the surface of the photoreceptive element comprises selectively exposing portions of the surface of the photoreceptive element to actinic radiation selected from the group consisting of ultraviolet radiation, visible light, and infrared radiation.

129. The method of claim 105, wherein the transfer assist material comprises an organosol having a glass transition temperature that is higher than the glass transition temperature of the liquid ink that comprises the toned image.

130. The method of claim 105, wherein the substantially dried composite image layer on the intermediate transfer member forms a cohesive film.

131. A method of producing a composite image on a final image receptor from image data in a multiple pass electrophotographic system, comprising the steps of:
providing a photoreceptive element having a determined processing cycle;
providing at least one development station containing charged toner particles dispersed in a first carrier liquid, wherein at least one of the photoreceptive element and each development station are moved into a processing position relative to each other and performing the following steps (a) through (c) for each development station during each complete processing cycle of the photoreceptive element;
(a) applying a substantially uniform first electrostatic potential to the surface of the photoreceptive element;
(b) selectively discharging portions of the surface of the photoreceptive element in an imagewise manner to create a first latent image having a second electrostatic potential that is less than the absolute value of the first electrostatic potential on the surface of the photoreceptive element; and
(c) exposing the surface of the photoreceptive element to the charged toner particles, wherein the charged toner particles selectively deposit on the discharged portions of the surface of the photoreceptive element to develop the first latent image and create a toned image;
providing a transfer assist material development station containing a liquid transfer assist material comprising particles dispersed in a second carrier liquid;
moving at least one of a heated intermediate transfer member and the transfer assist material development station into a processing position relative to each other and applying the transfer assist material to at least a portion of the surface of the intermediate transfer member that will receive the toned image;
contacting the toned image with a sufficient amount of heat and force from the intermediate transfer member to transfer at least a portion of the toned image from the photoreceptive element to the intermediate transfer member to form a composite image layer;
substantially drying the composite image layer to remove at least a major portion of the first carrier liquid, wherein at least a portion of the toned image is positioned to overlap at least a portion of the transfer assist material on the intermediate transfer member; and
contacting the composite image layer with a first side of a final image receptor having two sides and applying force to the second side of the final image receptor with a backup element causing the composite image layer to elastomerically transfer to the first side of the final image receptor.

132. The method of claim 131, further comprising the step of contacting the toned image on the photoreceptive element with a drying element prior to contacting the toned image with the intermediate transfer member.

133. The method of claim 132, wherein the drying element is heated.

134. The method of claim 132, wherein the drying element comprises a carrier liquid absorbent coating.

135. The method of claim 132, wherein the drying element is rotatable.

136. The method of claim 135, wherein the drying element is a belt.

137. The method of claim 131, wherein the substantially dried composite image layer comprises greater than 75% solids by weight.

138. The method of claim 131, wherein the force provided by the heated intermediate transfer member to transfer the toned image layer from the photoreceptive element to the intermediate transfer member is in the range of about 60 pounds to about 70 pounds of force.

139. The method of claim 131, wherein the force provided by the backup element to transfer the composite image layer from the intermediate transfer member to the final image receptor is in the range of about 60 pounds to about 70 pounds of force.

140. The method of claim 131, wherein the backup element is heated to at least 80° C.

141. The method of claim 131, wherein the backup element is heated to about 105° C.

142. The method of claim 131, wherein the steps (a) through (c) are repeated by at least two development stations, and wherein each sequence of the steps (a) through (c) is performed during a separate processing cycle of the intermediate transfer member.

143. The method of claim 131, wherein the photoreceptive element is rotatable.

144. The method of claim 143, wherein the photoreceptive element is a photoreceptive drum.

145. The method of claim 131, wherein the surface of the photoreceptive element has an adhesive strength measured according to JIS Z 0237-1980 “Testing Methods of Pressure Sensitive Adhesive Tapes and Sheets” greater than 150 grams-force before the step of applying the transfer material.

146. The method of claim 131, wherein the toner particles have a glass transition temperature of less than about 35° C.

147. The method of claim 131, wherein the first and second carrier liquids comprise the same chemical material.

148. The method of claim 131, wherein the transfer assist material is a non-pigmented liquid toner comprising charged transfer assist particles dispersed in a carrier liquid.

149. The method of claim 148, wherein the charged transfer assist particles are applied to at least a portion of the toned image on the intermediate transfer member by an electrodeposition coating method.

150. The method of claim 131, wherein the particles of the transfer assist material have surface release characteristics.

151. The method of claim 131, wherein the transfer assist material comprises an additive to enhance durability of the image layer on the final image receptor.

152. The method of claim 131, wherein the particles of the transfer assist material have a glass transition temperature between about −1° C. and 35° C.

153. The method of claim 131, wherein the final image receptor is paper.

154. The method of claim 131, wherein the step of selectively discharging portions of the surface of the photoreceptive element comprises selectively exposing portions of the surface of the photoreceptive element to actinic radiation selected from the group consisting of ultraviolet radiation, visible light, and infrared radiation.

155. The method of claim 131, wherein the transfer assist material comprises an organosol having a glass transition temperature that is higher than the glass transition temperature of the liquid ink that comprises the toned image.

156. The method of claim 131, wherein the substantially dried composite image layer forms a cohesive film.

157. A method of producing a composite image on a final image receptor from image data in a multiple pass electrophotographic system having a heated intermediate transfer member, comprising the steps of:
providing at least one development station comprising a photoreceptive element and charged toner particles dispersed in a first carrier liquid, wherein at least one of the photoreceptive element and each development station are moved into a processing position relative to each other and performing the following steps (a) through (d) for each development station during each complete processing cycle of the intermediate transfer member;
(a) applying a substantially uniform first electrostatic potential to the surface of the photoreceptive element;
(b) selectively discharging portions of the surface of the photoreceptive element in an imagewise manner to create a first latent image having a second electrostatic potential that is less than the absolute value of the first electrostatic potential on the surface of the photoreceptive element;
(c) exposing the surface of the photoreceptive element to the charged toner particles, wherein the charged toner particles selectively deposit on the discharged portions of the surface of the photoreceptive element to develop the first latent image and create a toned image; and
(d) transferring at least a portion of the toned image on the photoreceptive element to the intermediate transfer member through a sufficient amount of heat and force from the intermediate transfer member;
providing a transfer assist material development station containing a liquid transfer assist material comprising particles dispersed in a second carrier liquid;
moving at least one of the intermediate transfer member and the transfer assist material development station into a processing position relative to each other and applying the transfer assist material to at least a portion of the toned image during the processing cycle of the intermediate transfer member to form a composite image layer
substantially drying the composite image on the intermediate transfer member to remove at least a major portion of the second carrier liquid; and
contacting the composite image layer with a first side of a final image receptor having two sides and applying force to the second side of the final image receptor with a backup element, causing the composite image layer to elastomerically transfer to the first side of the final image receptor.

158. The method of claim 157, further comprising the step of contacting the toned image layer on the photoreceptive element with a drying element prior to contacting the toned image layer with the intermediate transfer member.

159. The method of claim 158, wherein the drying element is heated.

160. The method of claim 158, wherein the drying element comprises a carrier liquid absorbent coating.

161. The method of claim 158, wherein the drying element is rotatable.

162. The method of claim 161, wherein the drying element is a belt.

163. The method of claim 157, wherein the substantially dried composite image layer comprises greater than 75% solids.

164. The method of claim 157, wherein the force provided by the heated intermediate transfer member to transfer the toned image from the photoreceptive element to the intermediate transfer member is in the range of about 60 pounds to about 70 pounds of force.

165. The method of claim 157, wherein the force provided by the backup element to transfer the composite image layer from the intermediate transfer member to the final image receptor is in the range of about 60 pounds to about 70 pounds of force.

166. The method of claim 157, wherein the backup element is heated to at least 80° C.

167. The method of claim 157, wherein the backup element is heated to about 105° C.

168. The method of claim 157, wherein the steps (a) through (c) are repeated by at least two development stations, and wherein each sequence of the steps (a) through (c) is performed during a separate processing cycle of the intermediate transfer member.

169. The method of claim 157, wherein the photoreceptive element is rotatable.

170. The method of claim 169, wherein the photoreceptive element is a photoreceptive drum.

171. The method of claim 157, wherein the surface of the photoreceptive element has an adhesive strength measured according to JIS Z 0237-1980 “Testing Methods of Pressure Sensitive Adhesive Tapes and Sheets” greater than 150 grams-force before the step of applying the transfer material.

172. The method of claim 157, wherein the toner particles have a glass transition temperature of less than about 35° C.

173. The method of claim 157, wherein the first and second carrier liquids comprise the same chemical material

174. The method of claim 157, wherein the transfer assist material is a non-pigmented liquid toner comprising charged toner particles dispersed in a carrier liquid.

175. The method of claim 174, wherein the charged toner particles are applied to at least a portion of the toned image n the intermediate transfer member by an electrodeposition coating method.

176. The method of claim 157, wherein the transfer assist material comprises an additive to promote adhesion of the image layer to the final image receptor.

177. The method of claim 157, wherein the transfer assist material comprises an additive to enhance durability of the image layer on the final image receptor.

178. The method of claim 157, wherein the particles of the transfer assist material have a glass transition temperature between about −1° C. and about 35° C.

179. The method of claim 157, wherein the final image receptor is paper.

180. The method of claim 157, wherein the step of selectively discharging portions of the surface of the photoreceptive element comprises selectively exposing portions of the surface of the photoreceptive element to actinic radiation selected from the group consisting of ultraviolet radiation, visible light, and infrared radiation.

181. The method of claim 157, wherein the transfer assist material comprises an organosol having a glass transition temperature that is higher than the glass transition temperature of the liquid ink that comprises the toned image.

182. The method of claim 157, wherein the substantially dried composite image layer on the intermediate transfer member forms a cohesive film.

183. A method of producing a composite image on a final image receptor from image data in a multiple pass electrophotographic system having a heated intermediate transfer member, comprising the steps of:
providing a transfer assist material development station containing a liquid transfer assist material comprising particles dispersed in a first carrier liquid;
moving at least one of the intermediate transfer member and the transfer assist material development station into a processing position relative to each other and applying the transfer assist material to at least a portion of the intermediate transfer member;
providing at least one development station comprising a photoreceptive element and charged toner particles dispersed in a second carrier liquid, wherein at least one of the photoreceptive element and each development station are moved into a processing position relative to each other and performing the following steps (a) through (d) for each development station during each complete processing cycle of an intermediate transfer member;
(a) applying a substantially uniform first electrostatic potential to the surface of the photoreceptive element;
(b) selectively photodischarging portions of the surface of the photoreceptive element in an imagewise manner to create a first latent image having a second electrostatic potential that is less than the absolute value of the first electrostatic potential on the surface of the photoreceptive element;
(c) exposing the surface of the photoreceptive element to the charged toner particles, wherein the charged toner particles selectively deposit on the discharged portions of the surface of the photoreceptive element to develop the first latent image and create a toned image; and
(d) transferring at least a portion of the toned image on the photoreceptive element to overlap the transfer assist material on the intermediate transfer member through a sufficient amount of heat and force from the intermediate transfer member;
wherein the transfer assist material and the at least one toned image form a composite image layer
substantially drying the composite image layer to remove at least a major portion of the second carrier liquid on the intermediate transfer member in multiple processing cycles of the intermediate transfer member; and
contacting the composite image layer with a first side of a final image receptor having two sides and applying force to the second side of the final image receptor with a backup element causing the composite image layer to elastomerically transfer to the first side of the final image receptor.

184. The method of claim 183, further comprising the step of contacting the toned image on the photoreceptive element with a drying element prior to contacting the toned image with the intermediate transfer member.

185. The method of claim 184, wherein the drying element is heated.

186. The method of claim 184, wherein the drying element comprises a carrier liquid absorbent coating.

187. The method of claim 184, wherein the drying element is rotatable.

188. The method of claim 187, wherein the drying element is a belt.

189. The method of claim 183, wherein the substantially dried composite image layer comprises greater than 75% solids by weight.

190. The method of claim 183, wherein the force provided by the heated intermediate transfer member to transfer the toned image layer from the photoreceptive element to the intermediate transfer member is in the range of about 60 pounds to about 70 pounds of force.

191. The method of claim 183, wherein the force provided by the backup element to transfer the composite image layer from the intermediate transfer member to the final image receptor is in the range of about 60 pounds of force to about 70 pounds of force.

192. The method of claim 183, wherein the backup element is heated to at least 80° C.

193. The method of claim 183, wherein the backup element is heated to about 105° C.

194. The method of claim 183, wherein the steps (a) through (c) are repeated by at least two development stations, and wherein each sequence of the steps (a) through (c) is performed during a separate processing cycle of the intermediate transfer member.

195. The method of claim 183, wherein the photoreceptive element is rotatable.

196. The method of claim 195, wherein the photoreceptive element is a photoreceptive drum.

197. The method of claim 183, wherein the surface of the photoreceptive element has an adhesive strength measured according to JIS Z 0237-1980 “Testing Methods of Pressure Sensitive Adhesive Tapes and Sheets” greater than 150 grams-force before the step of applying the transfer material.

198. The method of claim 183, wherein the toner particles have a glass transition temperature of less than about 35° C.

199. The method of claim 183, wherein the first and second carrier liquids comprise the same chemical material

200. The method of claim 183, wherein the transfer assist material is a non-pigmented liquid toner comprising charged particles dispersed in a carrier liquid.

201. The method of claim 200, wherein the charged toner particles are applied to at least a portion of the toned image on the intermediate transfer member by an electrodeposition coating method.

202. The method of claim 183, wherein the particles of the transfer assist material have surface release characteristics.

203. The method of claim 183, wherein the transfer assist material comprises an additive to enhance durability of the image layer on the final image receptor.

204. The method of claim 183, wherein the particles of the transfer assist material have a glass transition temperature between about −1° C. and 35° C.

205. The method of claim 183, wherein the final image receptor is paper.

206. The method of claim 183, wherein the step of selectively discharging portions of the surface of the photoreceptive element comprises selectively exposing portions of the surface of the photoreceptive element to actinic radiation selected from the group consisting of ultraviolet radiation, visible light, and infrared radiation.

207. The method of claim 183, wherein the transfer assist material comprises an organosol having a glass transition temperature that is higher than the glass transition temperature of the liquid ink that comprises the toned image.

208. The method of claim 183, wherein the substantially dried composite image layer on the photoreceptive element forms a cohesive film.
